(19) United States
(12) Patent Application Publication
(10) Pub. No.: US 2018/0189109 A1
(43) Pub. Date: Jul. 5, 2018

(54) MANAGEMENT SYSTEM AND MANAGEMENT METHOD FOR COMPUTER SYSTEM

(71) Applicant: HITACHI, LTD., Tokyo (JP)

(72) Inventors: Takayuki NAGAI, Tokyo (JP); Satoshi KANEKO, Tokyo (JP); Hironori EMARU, Tokyo (JP); Shinichi HAYASHI, Tokyo (JP)

(73) Assignee: HITACHI, LTD., Tokyo (JP)

(21) Appl. No.: 15/740,688

(22) PCT Filed: Oct. 30, 2015
(86) PCT No.: PCT/JP2015/080652

§ 371 Date: Dec. 28, 2017

(51) Int. Cl. G06F 9/50; G06F 9/455

(52) U.S. Cl. CPC G06F 9/5077; G06F 2009/4557; G06F 9/45558; G06F 9/5072

(57) ABSTRACT

This management system for a computer system including a plurality of resources receives designation of an app usage and refers to management information, which includes information about the plurality of resources. The management system determines, for a target virtual server (a virtual server that executes the app for the designated app usage), at least one of the specification of resources to be allocated for exclusive use and the specification of resources to be allocated for shared use, in accordance with app requirements associated with the designated app usage. The plurality of resources includes a plurality of logical volumes and a plurality of computer resources including a plurality of kinds of computer resources. The computer system includes a server system including two or more computer resources included among the plurality of computer resources. The resource specifications include the kinds of resources, app usages associated with resources, and/or the number of resources.

### TECHNICAL FIELD

The present invention generally relates to management of a computer system.

### BACKGROUND ART

A computer system including a server and a storage is known. There is a need for integrating a plurality of application Programs (apps) in the computer system. To prevent the performance of one of the apps from affecting the performance of another one of the apps, it is desirable to logically partition resources of the computer system to execute a plurality of different apps in the logically partitioned different resources. According to PTL 1, logical partitioning is performed from a server system to a storage system.

### CITATION LIST

### Patent Literature

[PTL 1] Japanese Patent No. 4227035

### SUMMARY OF INVENTION

### Technical Problem

When the logical partitioning from server resources (computer resources of the server system) to storage resources (for example, logical volumes) is performed, the influence of adjacent virtual servers (for example, logical partitions (LPARs)) can be prevented. However, even when resources more than the allocated resources are necessary, the resources allocated for exclusive use to the other virtual servers cannot be used. If the logical partitioning from the server resources to the storage resources is performed for all of the virtual servers, the use efficiency of the resources is reduced.

Furthermore, it is difficult for a manager without highly specialized knowledge regarding the logical partitioning to realize logical partitioning according to the purpose, such as preventing performance competition between virtual servers.

### Solution to Problem

A management system for a computer system including a plurality of resources receives designation of an app usage and refers to management information, which is information including information about the plurality of resources. The management system determines, for a target virtual server (a virtual server that executes an app for the designated app usage), at least one of a specification of resources to be allocated for exclusive use and a specification of resources allocated for shared use, in accordance with app requirements associated with the designated app usage. The plurality of resources include a plurality of logical volumes and a plurality of computer resources including a plurality of kinds of computer resources. The computer system includes a server system including two or more computer resources included in the plurality of computer resources. The specifications of resources include at least one of the kind of resources, the app usage associated with the resources, and the number of resources. The resources belonging to the specification of resources allocated for exclusive use to the virtual server are resources exclusively used by the virtual server. The resources belonging to the specification of resources allocated for shared use to the virtual server are resources that can be shared by at least two virtual servers including the virtual server. Although an example of a realization method of the “virtual server” includes at least one of an LPAR and a VM (Virtual Machine), the “virtual server” may be a software container or the like instead. Although the LPAR will be described below as an example of the virtual server, it is obvious that realization methods of other virtual servers may also be adopted. The meaning of the term “server” of the “virtual server” is not limited to the server in a client server model, and the “server” may be broadly interpreted as a computer.

### Advantageous Effects of Invention

It is easy for the manager to perform logical partitioning that improves the app integration rate and that prevents affecting the performance.

### BRIEF DESCRIPTION OF DRAWINGS

FIG. 1 is a diagram showing a configuration example of an information system.

FIG. 2 is a diagram showing a configuration example of a host computer.

FIG. 3 is a diagram showing a configuration example of a storage apparatus.

FIG. 4 is a diagram showing a configuration example of a management server.

FIG. 5 is a diagram showing a configuration example of coupling of the host computers and the storage apparatus.

FIG. 6A is a diagram showing a configuration example of a server port management table.

FIG. 6B is a diagram showing a configuration example of the server port management table.

FIG. 7A is a diagram showing a configuration example of an LPAR management table.

FIG. 7B is a diagram showing a configuration example of the LPAR management table.

FIG. 7C is a diagram showing a configuration example of the LPAR management table.

FIG. 7D is a diagram showing a configuration example of the LPAR management table.

FIG. 8A is a diagram showing a configuration example of a storage port management table.

FIG. 8B is a diagram showing a configuration example of the storage port management table.

FIG. 8C is a diagram showing a configuration example of the storage port management table.

FIG. 9 is a diagram showing a configuration example of a RAID group management table.

FIG. 10 is a diagram showing a configuration example of a CLPR management table.

FIG. 11A is a diagram showing a configuration example of a volume management table.

FIG. 11B is diagram showing a configuration example of the volume management table.

FIG. 11C is a diagram showing a configuration example of the volume management table.

FIG. 12 is a diagram showing a configuration example of a storage partition management table.

FIG. 13A is a diagram showing a configuration example of a host management table.

FIG. 13B is a diagram showing a configuration example of the host management table.

FIG. 13C is a diagram showing a configuration example of the host management table.

FIG. 13D is a diagram showing a configuration example of the host management table.

FIG. 14 is a diagram showing a configuration example of a template management table.

FIG. 15 is a diagram showing a configuration example of a storage port exclusive use level management table.

FIG. 16A is part of a flow chart showing an example of an entire flow of a storage partition creation process.

FIG. 16B is other part of the flow chart showing the example of the entire flow of the storage partition creation process.

FIG. 16C is the rest of the flow chart showing the example of the entire flow of the storage partition creation process.

FIG. 17 is a flow chart showing an example of an entire flow of a provisioning process.

FIG. 18A is part of a flow chart showing an example of an entire flow of an app requirement changing process according to Embodiment 2.

FIG. 18B is other part of the flow chart showing the example of the entire flow of the app requirement changing process according to Embodiment 2.

FIG. 18C is the rest of the flow chart showing the example of the entire flow of the app requirement changing process according to Embodiment 2.

FIG. 19 is a diagram showing a configuration example of coupling of the host computers according to Embodiment 3.

FIG. 20 is a diagram showing a configuration example of the volume management table according to Embodiment 3.

FIG. 21A is part of a flow chart showing an example of an entire flow of an app requirement changing process according to Embodiment 3.

FIG. 21B is other part of the flow chart showing the example of the entire flow of the app requirement changing process according to Embodiment 3.

FIG. 21C is the rest of the flow chart showing the example of the entire flow of the app requirement changing process according to Embodiment 3.

### DESCRIPTION OF EMBODIMENTS

Hereinafter, some Embodiments will be described.

Although an expression of “xxx table” will be used in some cases to describe information in the following description, any data structure may be used to express the information. More specifically, the “xxx table” can be referred to as “xxx information” to indicate that the information does not depend on the data structure. Furthermore, in the following description, the configuration of each table is an example. One table may be divided into two or more tables, or all or part of two or more tables may form one table.

Furthermore, although an ID or a name will be used as identification information of an element in the following description, other types of identification information may be used in place of or in addition to the ID or the name.

Furthermore, in the following description, a reference sign (or a common sign in the reference sign) can be used when the same kind of elements are described without distinguishing the elements, and element identification information (identification information such as IDs and names assigned to the elements) (or reference signs) can be used when the same kind of elements are distinguished and described.

Furthermore, in the following description, an I/O (Input/Output) request is a write request or a read request and may be referred to as an access request.

Furthermore, a “storage unit” may be one or more storage devices including a memory in the following description. For example, of a main storage device (typically, a volatile memory) and an auxiliary storage device (typically, a non-volatile storage device), the storage unit may be at least the main storage device.

Furthermore, although a “program” serves as a subject in some cases to describe a process in the following description, the program is executed by a processor (for example, a CPU (Central Processing Unit)) to execute a predetermined process while appropriately using a storage unit (for example, a memory) and/or an interface device (for example, a communication port), etc. Therefore, the subject of the process may be the processor. The process described with the program serving as the subject may be handled as a process executed by the processor or by one of an apparatus and a system including the processor. Furthermore, the processor is an example of a control unit, and the processor may include a hardware circuit that executes part or all of the process. The program may be installed on an apparatus, such as a computer, from a program source. The program source may be, for example, a program distribution server or a computer-readable storage medium. When the program source is a program distribution server, the program distribution server may include a processor (for example, a CPU) and a storage unit, and the storage unit may further store a distribution program and a distribution target program. The processor of the program distribution server may execute the distribution program, and in this way, the processor of the program distribution server may distribute the distribution target program to another computer. Furthermore, in the following description, two or more programs may be realized as one program, and one program may be realized as two or more programs.

Furthermore, a management system may include one or more computers in the following description. Specifically, for example, when a management computer displays information (specifically, for example, when the management computer displays information on a display device of the management computer, or when the management computer (for example, a management server) transmits information for display to a remote computer for display (for example, a management client)), the management computer is the management system. Furthermore, for example, when a plurality of computers realize a function identical or similar to the management computer, the plurality of computers (may include a computer for display when the computer for display performs the display) are the management system. The management computer (for example, a management system) may include: an interface device coupled to an I/O system including a display system; a storage unit (for example, a memory); and a processor coupled to the interface device and the storage unit. The display system may be a display device included in the management computer or may be a computer for display coupled to the management computer. The I/O system may be an I/O device (for example, a keyboard, a pointing device, and a touch panel) included in the management computer or may be a computer for display or another computer coupled to the management computer. The phrase “display of the information for display” by the management computer denotes display of the information for display on the display system. This may be display of the information for display on the display device included in the management computer or may be transmission of the information for display to the computer for display by the management computer (in the latter case, the computer for display displays the information for display). Furthermore, input and output of information by the management computer may be input and output of the information to and from the I/O device included in the management computer or may be input and output of the information to and from a remote computer (for example, a computer for display) coupled to the management computer. The output of the information may be display of the information.

Furthermore, of a server system (one or more server apparatuses) and a storage system (one or more storage apparatuses), the computer system includes at least the server system. In the following description, “resources” may be components included in at least one of the server system and the storage system. The components include physical components (for example, CPUs, memories, HBAs (Host Bus Adapters), ports, and drives (physical storage devices)) as well as logical components (for example, VOLs (logical volumes)). Furthermore, any of the components existing outside of the server and the storage, such as relay devices existing between the server system and the storage system (for example, a switch with a routing function or a port expansion device without a routing function), relay devices existing between server systems, and relay devices existing between storage systems, may be handled as examples of the “resources”. Furthermore, components (for example, ports and cores (controllers)) of the relay devices may also be handled as examples of the “resources”.

Furthermore, in the following description, “X is allocated for exclusive use to Y1” denotes that X (for example, resources) is allocated to Y1 (for example, a first LPAR) and is not allocated to Y2 (for example, a second LPAR) that is another object of the same kind as Y1. As a result, X is exclusively used by Y1. On the other hand, “X is allocated for shared use to Y1” denotes that X is allocated to Y1, and X can also be allocated to Y2. As a result, X can be shared by Y1 and Y2.

Furthermore, in the following description, “resources for exclusive use” are resources allocated for exclusive use, and “resources for shared use” are resources allocated for shared use.

### Embodiment 1

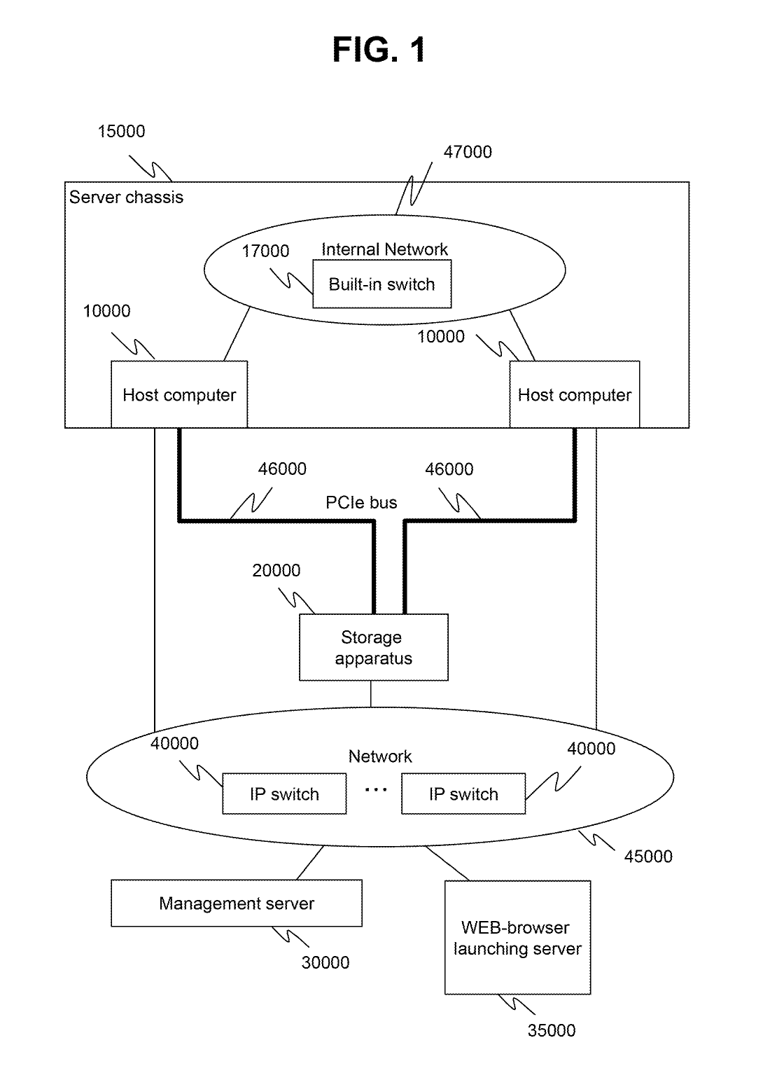

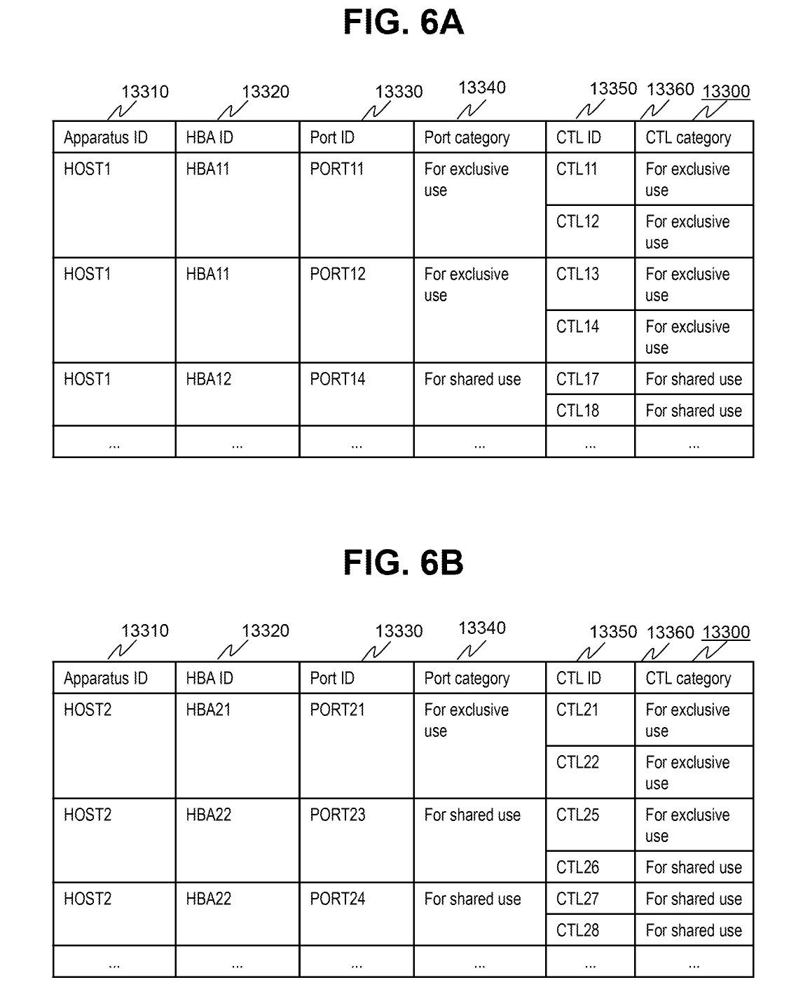

FIGS. 1 to 5 show a configuration example of an information system and configuration examples of apparatuses in the information system. FIGS. 6 to 15 show configuration examples of management tables.

FIG. 1 is a diagram showing an example of physical configuration of the information system.

The information system includes a storage apparatus 20000, host computers 10000, a server chassis 15000, a management server 30000, and a WEB-browser launching server 35000. These are coupled through a network 45000 (for example, IP (Internet Protocol) switches 40000) and PCIe buses 46000. A computer system includes the storage apparatus 20000 (example of a storage system) and the server chassis 15000 (example of a server system) including the plurality of host computers 10000. Of the management server 30000 (example of a management computer configured to manage the computer system) and the WEB-browser launching server 35000 (example of a computer for display such as a client), a management system includes at least the management server 30000.

The host computers 10000 are an example of server apparatuses (physical server apparatuses). The host computers 10000 receive, for example, I/O requests of files from client computers (not shown) and realize access to the storage apparatus 20000 based on the I/O requests. The host computers 10000 and the storage apparatus 20000 are coupled through the PCIe (PCI-Express) buses 46000.

The server chassis 15000 is provided with the host computers 10000. An internal network 47000 including a built-in switch 17000 (for example, IP switch) exists inside of the server chassis 15000.

The management server 30000 manages operation of the entire computer system through the network 45000.

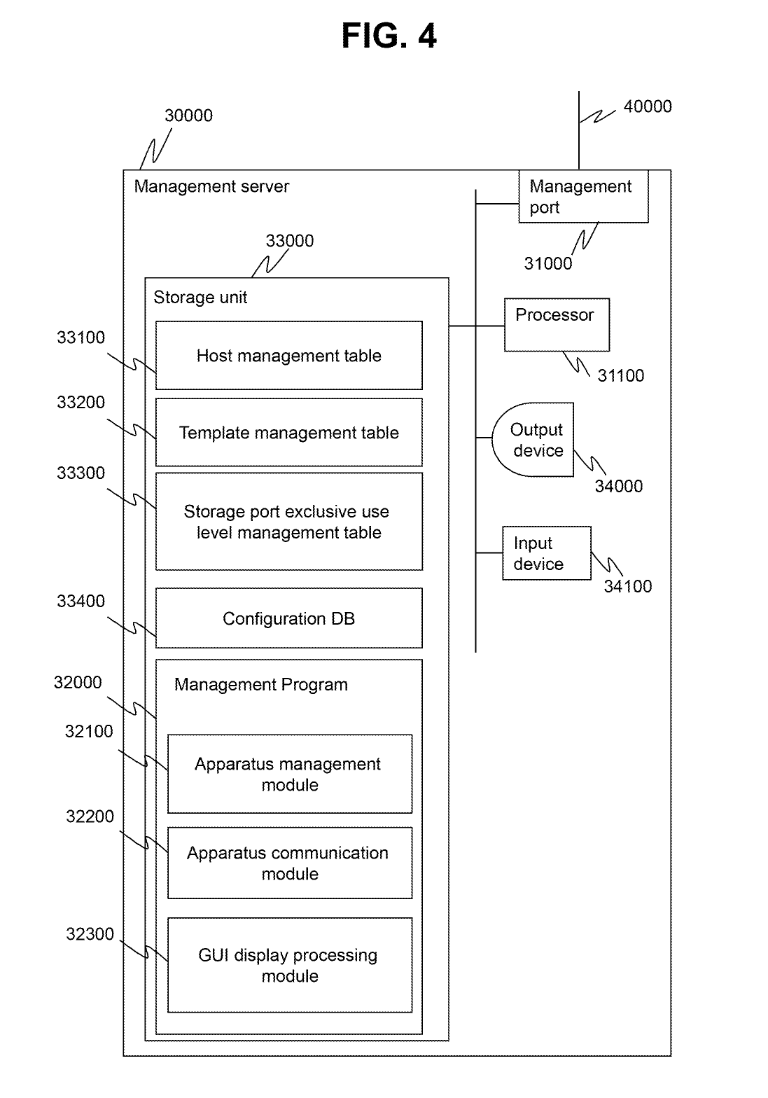

The WEB-browser launching server 35000 is a computer that communicates with a GUI display processing module 32300 (see FIG. 4) of the management server 30000 through the network 45000 and displays various types of information on a WEB browser. A manager refers to the information displayed on the WEB browser of the WEB-browser launching server 35000 to manage the apparatuses in the computer system. However, the management server 30000 and the WEB-browser launching server 35000 may be constituted by one server.

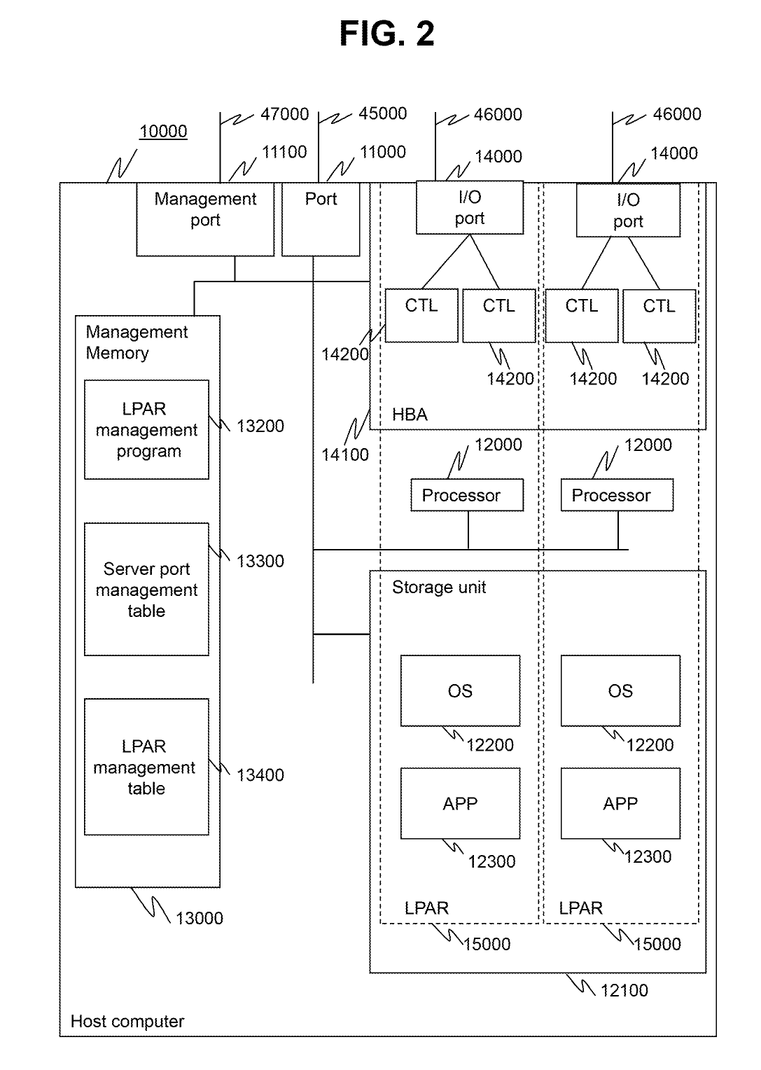

FIG. 2 is a diagram showing a configuration example of the host computer 10000.

The host computer 10000 includes: a port 11000 for coupling to the network 45000; a management port 11100 for coupling to the internal network 47000 of the server chassis 15000; processors (CPUs) 12000; a storage unit 12100; a management memory 13000 (may include a physical storage device other than the memory); I/O ports 14000 for coupling to the PCIe buses 46000; controllers 14200 coupled to the I/O ports 14000; and an HBA 14100 provided with the I/O ports 14000 and the controllers 14200. These elements are coupled to each other through a circuit such as an internal bus. The number of at least one of these elements may be one or more. In one HBA 14100, the number of at least one of the I/O ports 14000 and the controllers 14200 may be one or more. The I/O ports 14000 are an example of server ports. The HBA 14100 is an example of an interface device included in the server system (server apparatus) and communicates with the storage system.

Programs, such as an LPAR management program 13200, and information, such as a server port management table 13300 and an LPAR management table 13400, are stored in the management memory 13000. The management memory 13000 is an example of a memory.

The LPAR management program 13200 creates LPARs 15000 by logically partitioning computer resources, such as the I/O ports 14000, the processors 12000, and the storage unit 12100 on the host computer 10000. However, the I/O ports 14000 may be shared between the LPARs. The resources that can be allocated to the LPAR 15000 include the I/O ports 14000, the processors 12000, the storage unit 12100, the controllers 14200, and the HBA 14100. The storage unit 12100 may be, for example, one or more memories.

The LPAR 15000 recognizes, as storage areas, logical volumes on the storage apparatus 20000 through the PCIe bus 46000. In addition, an OS (operating system) 12200 and an app 12300 are stored in each LPAR 15000. The LPAR 15000 executes the OS 12200 and the app 12300. One LPAR 15000 executes one or a plurality of apps 12300.

Furthermore, a virtualization control program may be used in place of the LPAR management program 13200 described in FIG. 2. The virtualization control program may abstract or standardize physical resources, such as the processors 12000 and the storage unit (memory) 12100, to provide virtual hardware to a VM (virtual machine). In that case, the LPAR is equivalent to the VM, and the virtualization control program is equivalent to the LPAR management program in the following description.

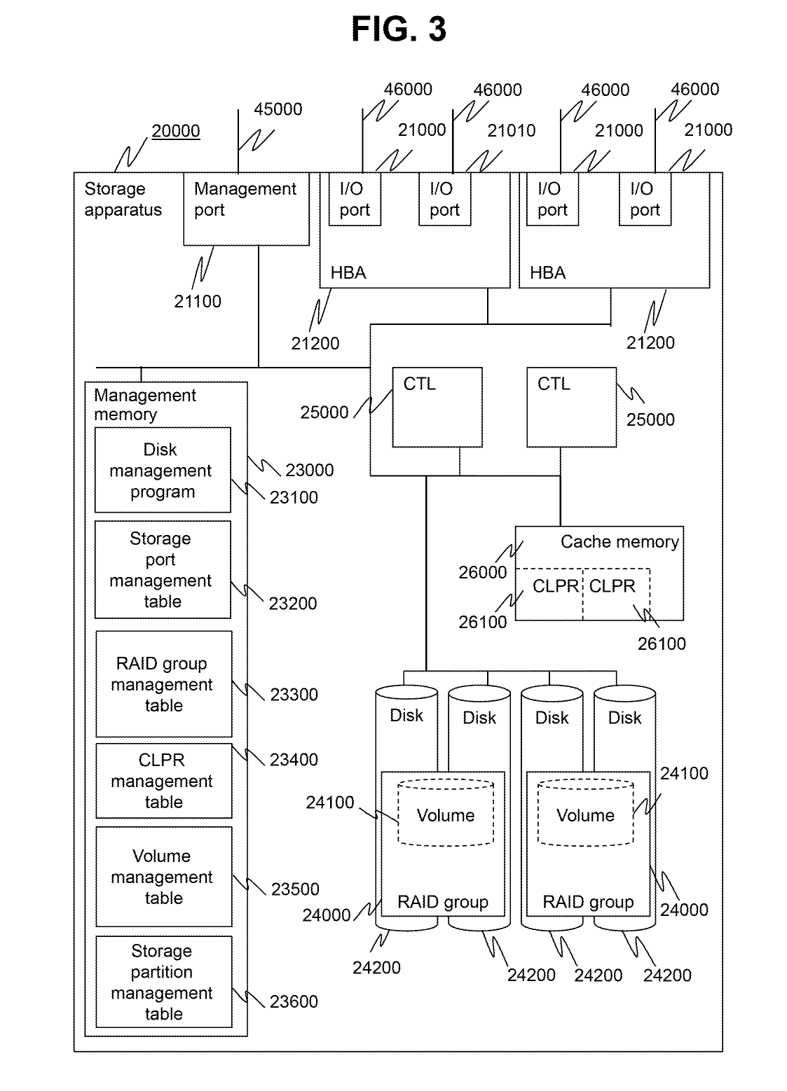

FIG. 3 is a diagram showing a configuration example of the storage apparatus 20000.

The storage apparatus 20000 includes: I/O ports 21000 for coupling to the host computers 10000 through the PCIe buses 46000; a management port 21100 for coupling to the management server 30000 through the network 45000; a management memory 23000 for storing various management tables; RAID groups 24000 for storing data; controllers 25000 that execute control using the data and the management tables in the management memory; and a cache memory (cache) 26000 that temporarily holds I/O target data according to I/O requests from the host computers. These elements are coupled to each other through a circuit such as an internal bus. The number of at least one of the elements may be one or more.

Programs, such as a disk management program 23100, and information, such as a storage port management table 23200, a RAID group management table 23300, a CLPR management table 23400, a volume management table 23500, and a storage partition management table 23600, are stored in the management memory 23000 (may include a physical storage device other than the memory). The management memory 23000 is an example of a memory. The management program communicates with the management server 30000 through the management port 21100, and the controllers 25000 provide information of the storage apparatus 20000 (for example, information about the configuration of the storage apparatus 20000 including at least part of the management tables 23200, 23300, 23400, 23500, and 23600) to the management server. The I/O ports 21000 are an example of storage ports.

The RAID group 24000 includes one or a plurality of disk devices 24200. When the RAID group 24000 includes a plurality of disk devices, the disk devices may form a RAID configuration. Furthermore, one or a plurality of logical volumes 24100 are provided as logical storage areas based on the RAID groups 24000. The logical volume 24100 is an example of storage resource. The logical volume 24100 may be provided to the host computers or may configure a pool. In the latter case, in place of the logical volume 24100, virtual volume (logical volume including a plurality of virtual areas (virtual storage areas) and in compliance with a capacity virtualization technique (typically, Thin Provisioning)) may be provided to the host computers. The “pool” is a logical storage area (for example, a set of a plurality of logical volumes). The pool may be a storage area including a plurality of real areas (substantive storage areas) (the logical volume 24100 may be divided into two or more real areas). When a real area is not allocated to the virtual area (virtual area of virtual volume) to which the address designated by a write request received from the host computer belongs, the controller 25000 may allocate a real area to the virtual area from the pool and may write, in the allocated real area, write target data associated with the write request.

Note that the logical volume 24100 may not have a RAID configuration as long as the logical volume 24100 is constituted by using the storage areas of one or more disk devices 24200. Furthermore, other physical storage devices, such as flash memory devices, may be adopted in place of the disk devices.

The controller 25000 may include, inside of the controller 25000, a processor that controls the inside of the storage apparatus 20000 and a temporary storage area for temporarily storing data to be exchanged with the host computer 10000. The controller 25000 lies between the I/O ports 21000 and the RAID groups 24000 and transfers data between the I/O ports 21000 and the RAID groups 24000.

The cache 26000 may be logically partitioned to prepare one or more CLPRs 26100. The “CLPR” is an abbreviation of a cache LPAR. One or more CLPRs 26100 may be associated with each logical volume 24100. This can prevent interference of I/O performance between the logical volumes in the cache 26000.

Note that the storage apparatus 20000 may have a configuration other than the configuration in FIG. 3 or the configuration described above as long as the storage apparatus 20000 includes: a storage controller that provides logical volume (or virtual volume) to one of the host computers, receives I/O requests (may also be referred to as access requests), and performs reading and writing in the disk devices 24200 according to the received I/O requests; and a disk device that provides a storage area. For example, the storage controller and the storage device that provides the storage area may be stored in different enclosures. That is, the management memory 23000 and the controllers 25000 and 25110 may be the storage controller in the example of FIG. 3. Furthermore, in the present description, the storage apparatus may be referred to as a storage system to express cases in which the storage controller and the storage device exist in the same enclosure and in different enclosures.

FIG. 4 is a diagram showing a configuration example of the management server 30000.

The management server 30000 includes: a management port 31000 for coupling to the network 45000; a processor 31100; a storage unit 33000; an output device 31200 such as a display apparatus for outputting a processing result described later; and an input device 31300, such as a keyboard, for the manager to input an instruction. These elements are coupled to each other through a circuit such as an internal bus. The number of at least one of the elements may be one or more. The management port 31000 is an example of an interface device.

Programs, such as a management program 32000, are stored in the storage unit 33000. The management program 32000 includes an apparatus management module 32100, an apparatus communication module 32200, and the GUI display processing module 32300. Although the modules are provided as program modules of the storage unit memory 33000, the modules may be provided as hardware modules. Furthermore, the management program 32000 may not be constituted by modules as long as processing by each module can be realized. In other words, the description regarding each module in the following description may be restated as description about the management program 32000.

Information, such as a host management table 33100, a template management table 33200, a storage port exclusive use level management table 33300, and a configuration DB 33400, is further stored in the storage unit 33000. Configuration information is stored in the configuration DB 33400. At least part of the information including these pieces of information is an example of management information.

Examples of the configuration information include: each item of the server port management table 13300 collected by the apparatus communication module 32200 from each host computer of a management target; each item of the LPAR management table 13400; each item of the storage port management table 23200 collected from each storage of the management target; each item of the RAID group management table 23300; each item of the CLPR management table 23400; each item of the volume management table 23500; and each item of the storage partition management table 23600. Note that the configuration DB 33400 may not store all of the tables of the management target apparatus or all of the items in the tables. Furthermore, the data expression format and the data structure of each item stored in the configuration DB 33400 may not be the same as in the management target apparatus. Furthermore, when the management program 32000 receives the items from the management target apparatus, the items may be received in the data structure and the data expression format of the management target apparatus.

The apparatus communication module 32200 periodically or repeatedly accesses the management target apparatus under the management and acquires the configuration information of each component in the management target apparatus. Note that when the execution instruction is to be repeatedly issued, the execution instruction may not be issued at exactly every certain period, and it is only necessary that the execution instruction be repeatedly issued.

Furthermore, the apparatus communication module 32200 instructs the management target apparatus under the management to change the configuration according to a request from the manager (an example of a user). After instructing the management target apparatus to change the configuration, the apparatus communication module 32200 reacquires the configuration information of each component in the management target apparatus and maintains the latest state of the configuration information stored in the configuration DB 33400.

The GUI display processing module 32300 displays the acquired configuration management information through the output device 31200 according to the request from the manager through the input device 31300. Note that the input device and the output device may be separate devices or may be one or more integrated devices.

Although the management server (management computer) includes, for example, a display, a keyboard, a pointer device, and the like as input and output devices, the management server may be other apparatuses. Furthermore, a serial interface or an Ethernet interface may be used in place of the input and output devices. A computer for display (for example, the WEB-browser launching server 35000) including a display, a keyboard, or a pointer device may be coupled to the interface to transmit information for display to a computer for display or to receive information for input from the computer for display. In this way, the computer for display may display the information, or the input of the information may be received to thereby replace the input and the display in the input and output devices.

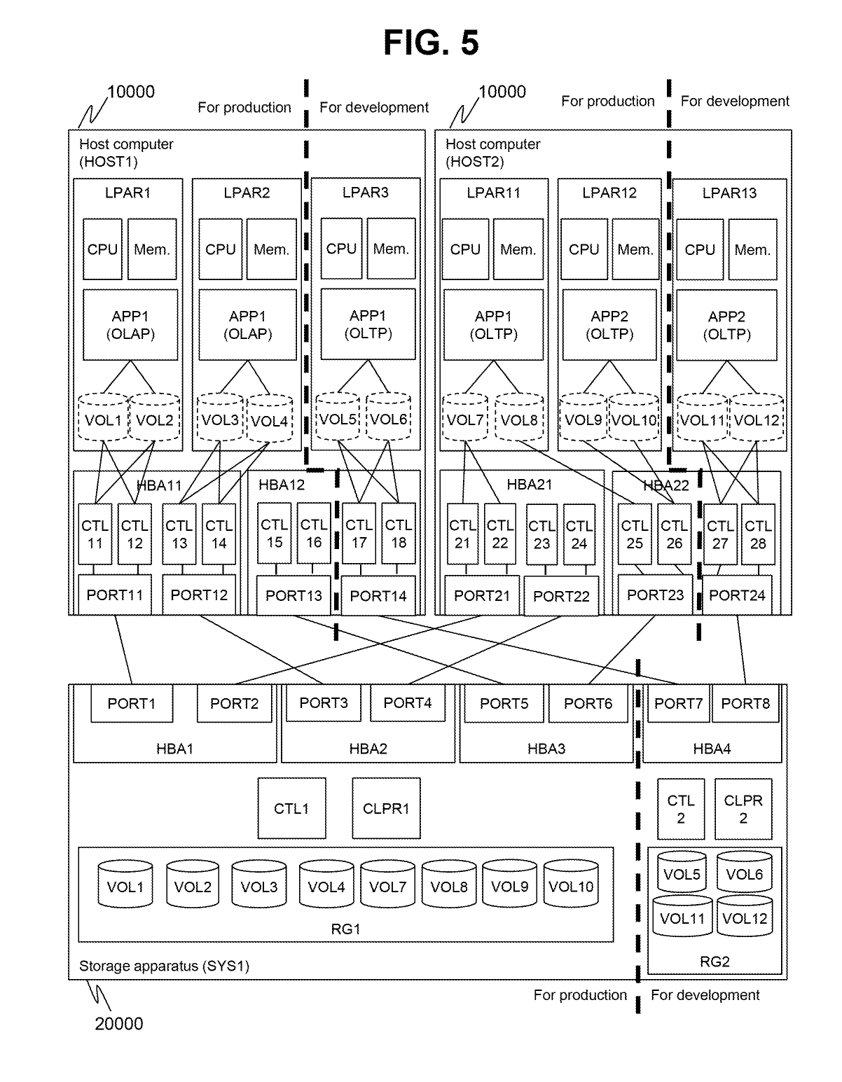

FIG. 5 is a diagram showing a configuration example of coupling of the host computers 10000 and the storage apparatus 20000.

I/O ports (PORT11, PORT12, . . . ) of the host computers 10000 and I/O ports (PORT1, PORT2, . . . ) of the storage apparatus 20000 are coupled to each other through the PCIe buses 46000. Although the I/O ports of the host computers and the storage are coupled through the PCIe buses in the present embodiment, it is only necessary that the I/O ports of the host computers and the storage be coupled one-to-one, and the I/O ports may be coupled through other media such as FC cables. The number of PCIe buses coupling the I/O ports of the host computers and the storage may not be one per I/O port, and a plurality of I/O ports may share one PCIe bus. According to FIG. 5, each of the host computers (HOST1 and HOST2) is divided into two host subsystems by logically partitioning the resources of the host computers 10000 from the highest resource to the lowest resource. One host subsystem is a host production system belonging to a production environment, and the other subsystem is a host development system belonging to a development environment (test environment). Furthermore, according to FIG. 5, the storage apparatus (SYS1) is also divided into two storage subsystems by logically Partitioning the resources of the storage apparatus from the highest resource to the lowest resource. One storage subsystem is a storage production system belonging to the production environment, and the other subsystem is a storage development system belonging to the development environment. There may be an LPAR including part of the storage production system and the production system of the HOST1 (LPAR associating part of the storage production system and the production system of the HOST1) and another LPAR including other part of the storage production system and the production system of the HOST2 (another LPAR associating other part of the storage production system and the production system of the HOST2). Although all of the resources belonging to the development systems including the host development system and the storage development system may be resources for shared use, part of the resources belonging to the development systems may be resources for exclusive use.

In the following description, identifiers of the resources (identifiers illustrated in FIG. 5) may be appropriately used in place of the names of the resources.

FIGS. 6A and 6B are diagrams showing configuration examples of the server port management tables 13300 in the host computers 10000. Specifically, FIG. 6A shows a configuration example of the server port management table 13300 of the HOST′. FIG. 6B shows a configuration example of the server port management table 13300 of the HOST2.

The server port management table 13300 includes information about the I/O ports (example of server ports) of the host computer. Specifically, for example, the server port management table 13300 includes configuration items including: a field 13310 for registering the identifier of the host computer; a field 13320 for registering the identifier of each HBA in the host computer; a field 13330 for registering the identifier of the I/O port mounted on the HBA in the host computer; a field 13340 for registering the identifiers of the controllers coupled to the I/O port in the host computer; a field 13350 for registering the allocation category of each I/O port; and a field 13360 for registering the allocation category of each controller.

According to FIG. 6A, the following can be stated, for example. The HOST1 includes the HBA11. The HBA11 includes the PORT11. The PORT11 is coupled to the CTL11 and the CTL12. The PORT11, the CTL11, and the CTL12 are resources for exclusive use.

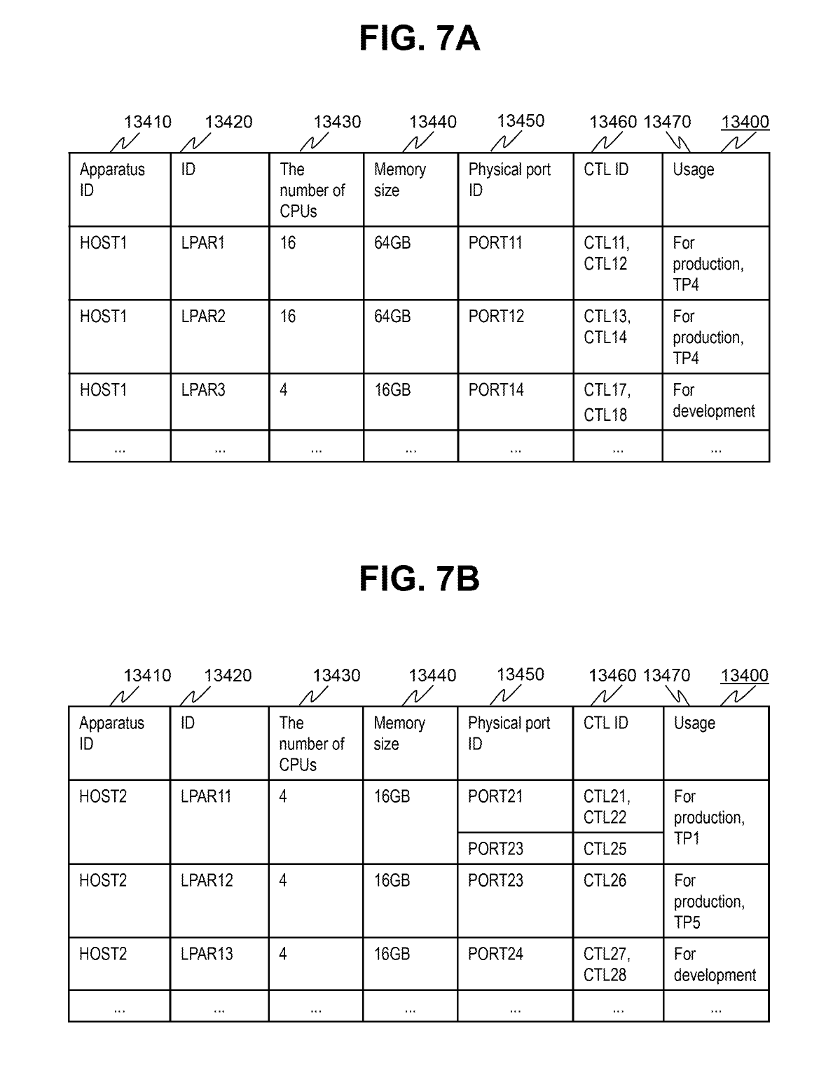

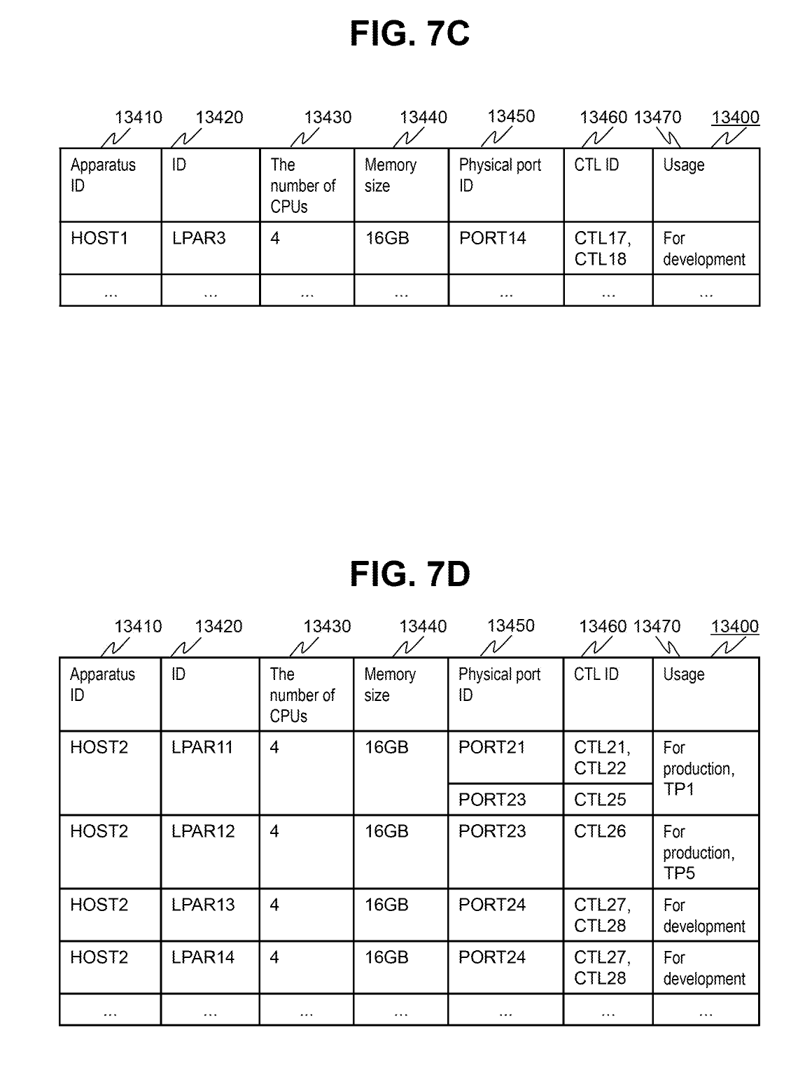

FIGS. 7A to 7D are diagrams showing configuration examples of the LPAR management tables 13400 in the host computers 10000. Specifically, FIGS. 7A and 7C show configuration examples of the LPAR management table 13400 of the HOST1. FIGS. 7B and 7D show configuration examples of the LPAR management table 13400 of the HOST2.

The LPAR management table 13400 includes information about the LPARs to which the computer resources of the host computer are allocated. Specifically, for example, the LPAR management table 13400 includes configuration items including: a field 13410 for registering the identifier of the host computer; a field 13420 for registering the identifier of each LPAR in the host computer; a field 13430 for registering the number of CPUs allocated to each LPAR; a field 13440 for registering the size of the memory allocated to each LPAR; a field 13450 for registering the ID of the I/O port allocated to each LPAR; a field 13460 for registering the IDs of the controllers allocated to each LPAR; and a field 13470 for registering whether the app mounted on each LPAR is for production or for development.

According to FIG. 7A, the following can be stated, for example. There is an LPAR1 to which part of the resources of the HOST1 is allocated. Sixteen CPUs, a memory of 64 GB, the PORT11, the CTL11, and the CTL12 are allocated to the LPAR1. The LPAR1 exists in the production system. The LPAR1 is provided with an app for production.

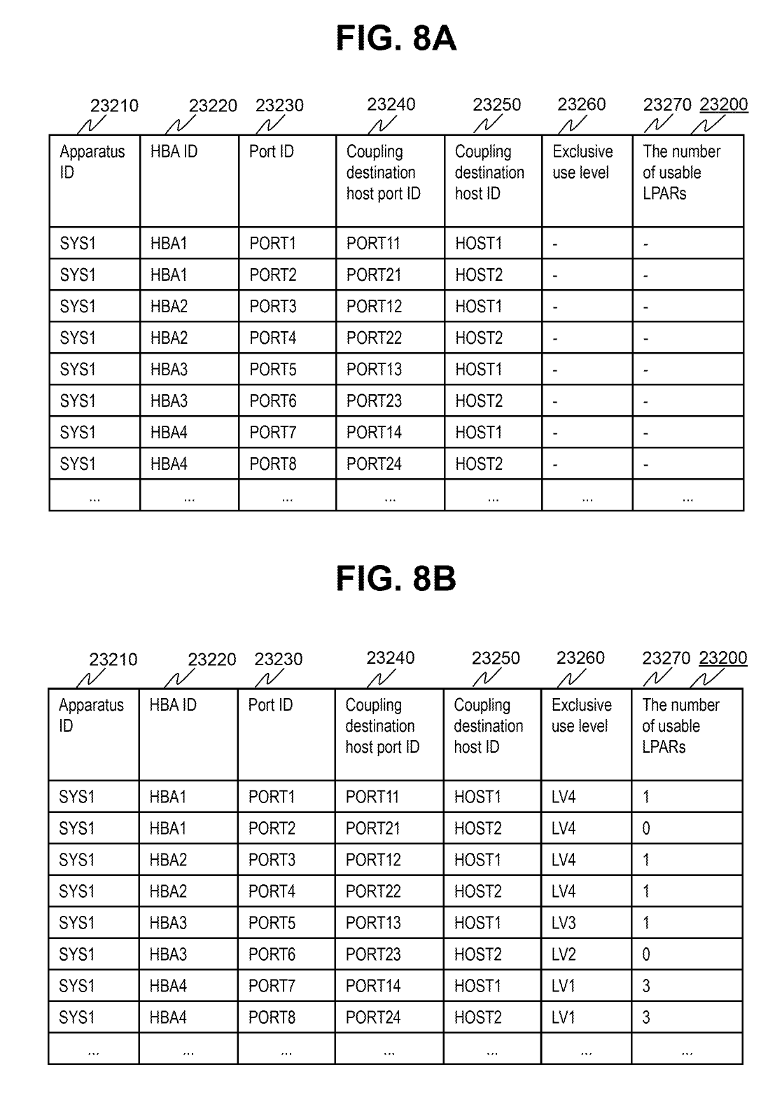

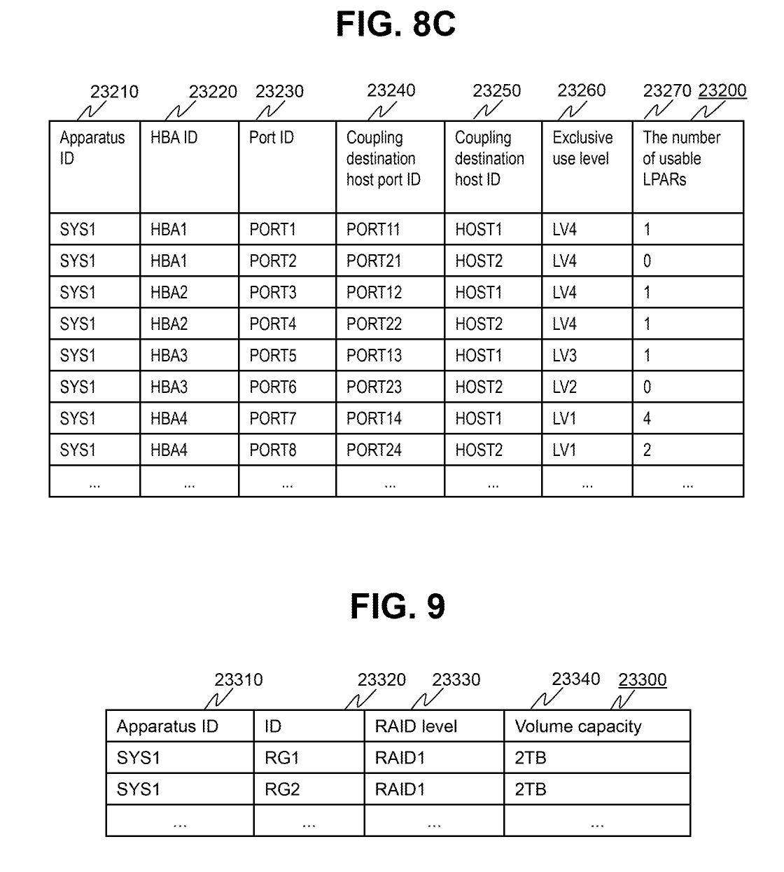

FIGS. 8A and 8B are diagrams showing configuration examples of the storage port management table 23200 in the storage apparatus 20000.

The storage port management table 23200 includes information about the I/O ports (example of storage ports) of the storage apparatus. Specifically, for example, the storage port management table 23200 includes configuration items including: a field 23210 for registering the identifier of the storage apparatus; a field 23220 for registering an HBAID that is the identifier of the HBA in the storage apparatus; a field 23220 for registering a port ID that is the identifier of the port existing on the HBA in the storage apparatus; a field 23240 for registering the ID of the port of the host computer directly connected to the port; a field 23250 for registering the ID of the host computer to which the port belongs; a field 23260 for registering an exclusive use level of each port; and a field 23270 for registering the number of LPARs that can be created on each port.

According to FIG. 8A, the following can be stated, for example. The HBA1 on the storage apparatus SYS1 includes the PORT1. The PORT11 of the HOST1 is directly connected to the PORT1. The term “direct connection” here denotes coupling according to a one-to-one coupling relationship between the I/O port of the host computer and the I/O port of the storage apparatus.

FIG. 9 is a diagram showing a configuration example of the RAID group management table 23300 in the storage apparatus 20000.

The RAID group management table 23300 includes information about the RAID groups. Specifically, for example, the RAID group management table 23300 includes: a field 23310 for registering the identifier of the storage apparatus; a field 23320 for registering a RAID group ID that is the identifier of each RAID group in the storage apparatus; a field 23330 for registering the RAID level of the RAID group; and a field 23340 for registering the capacity of each RAID group.

According to FIG. 9, the following can be stated, for example. The SYS1 includes a RAID group RG1. The RAID level of the RG1 is RAID1, and the capacity of the RG1 is 10 TB.

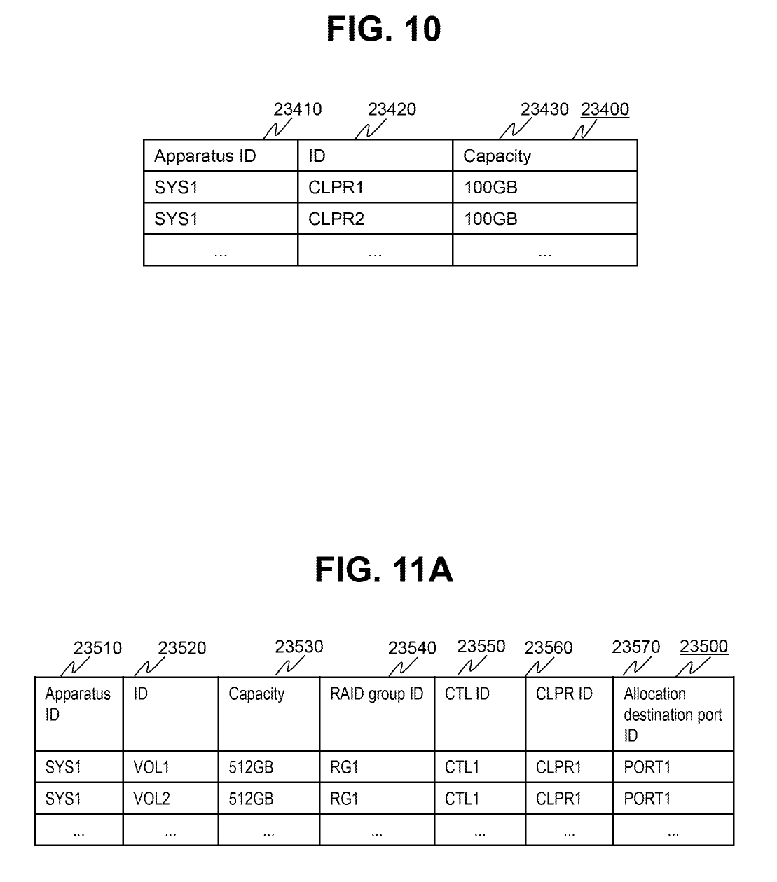

FIG. 10 is a diagram showing a configuration example of the CLPR management table 23400 in the storage apparatus 20000.

The CLPR management table 23400 includes information about the CLPRs. Specifically, for example, the CLPR management table 23400 includes: a field 23410 for registering the identifier of the storage apparatus; a field 23420 for registering a CLPR ID that is the identifier of each CLPR in the storage apparatus; and a field 23430 for registering the capacity of each CLPR.

According to FIG. 10, the following can be stated, for example. The SYS1 includes a CLPR1. The capacity of the CLPR1 is 100 GB.

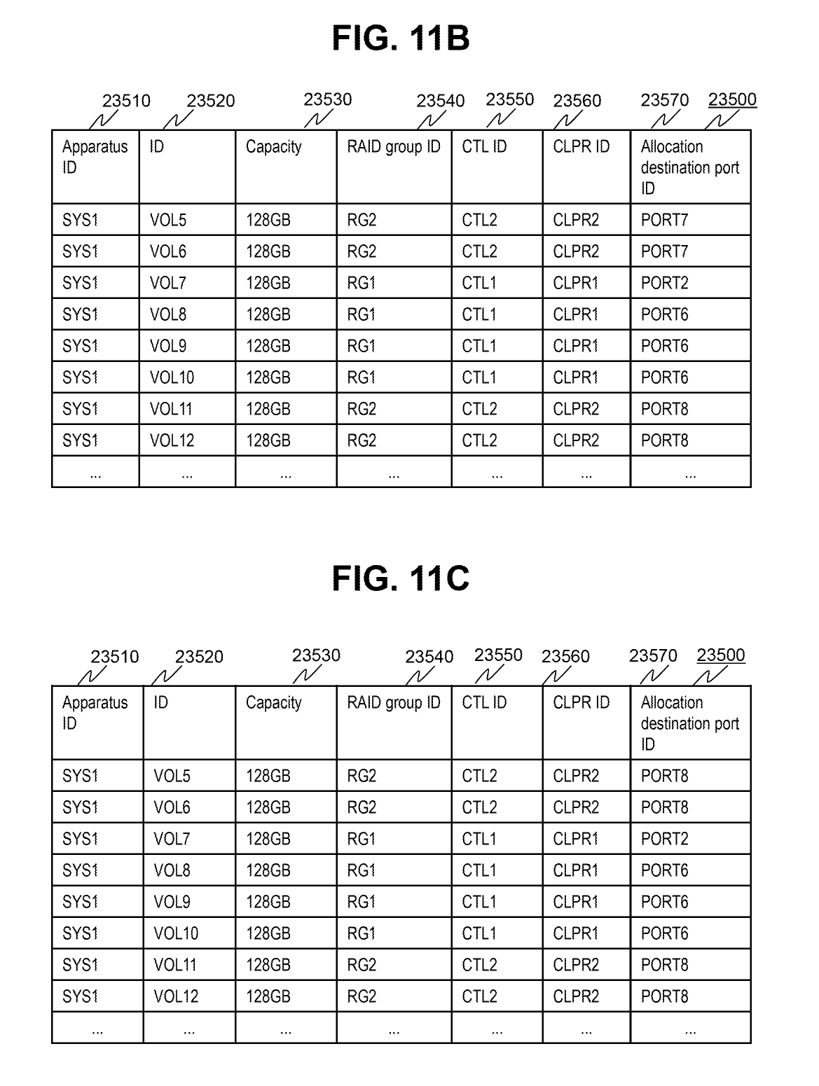

FIGS. 11A to 11C are diagrams showing configuration examples of the volume management table 23500 in the storage apparatus 20000.

The volume management table 23500 includes information about the logical volumes (may include information about the virtual volumes when the virtual volumes are provided to the host computers). Specifically, for example, the volume management table 23500 includes configuration items including: a field 23510 for registering the identifier of the storage apparatus; a field 23520 for registering a volume ID that is the identifier of each volume in the storage apparatus; a field 23530 for registering the capacity of each volume; a field 23540 for registering the RAID group ID that is the identifier of the RAID group to which each volume belongs; a field 23550 for registering a controller ID that is the identifier of the controller used by each volume; a field 23560 for registering the CLPR ID that is the identifier of the CLPR used by each volume; and a field 23570 for registering the ID of the coupling destination port of each volume.

According to FIG. 11A, the following can be stated, for example. The SYS1 includes a VOL1. The capacity of the VOL1 is 512 GB. The VOL1 belongs to the RG1. The CTL1 and CLPR1 are used to access the VOL1. When an I/O request designating the VOL1 is received through the PORT1, I/O according to the I/O request is performed.

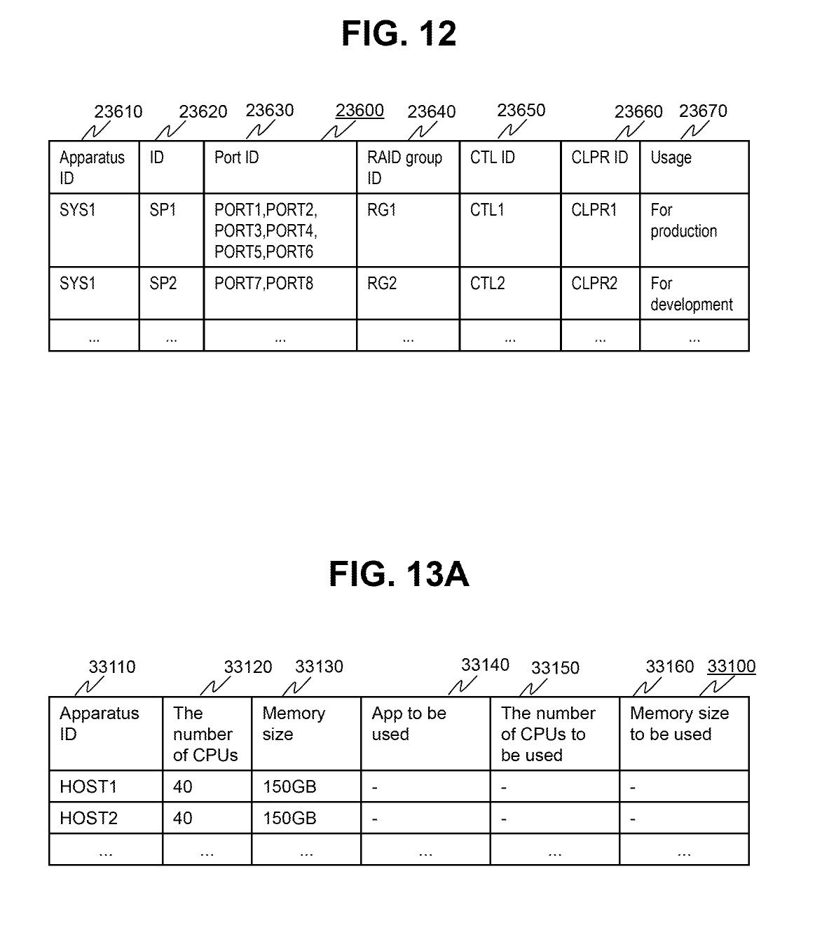

FIG. 12 is a diagram showing a configuration of the storage partition management table 23600 in the storage apparatus 20000.

The storage partition management table 23600 includes information about storage partitions (storage LPARs). Specifically, for example, the storage partition management table 23600 includes configuration items including: a field 23610 for registering the identifier of the storage apparatus; a field 23620 for registering a storage partition ID that is the identifier of the storage partition in the storage apparatus; a field 23630 for registering the port ID that is the identifier of the port in the storage apparatus associated with the storage partition; a field 23640 for registering the RAID group ID that is the identifier of the RAID group in the storage apparatus associated with the storage partition; a field 23650 for registering the controller ID that is the identifier of the controller in the storage apparatus associated with the storage partition; a field 23660 for registering the CLPR ID that is the identifier of the CLPR in the storage apparatus associated with the storage partition; and a field 23670 for registering a usage of the storage partition.

According to FIG. 12, the following can be stated, for example. The SYS1 includes a storage partition SP1. The PORT1, the PORT2, the PORT3, the PORT4, the PORT5, the PORT6, the RG1, the CTL1, and the CLPR1 are allocated to (associated with) the SP1.

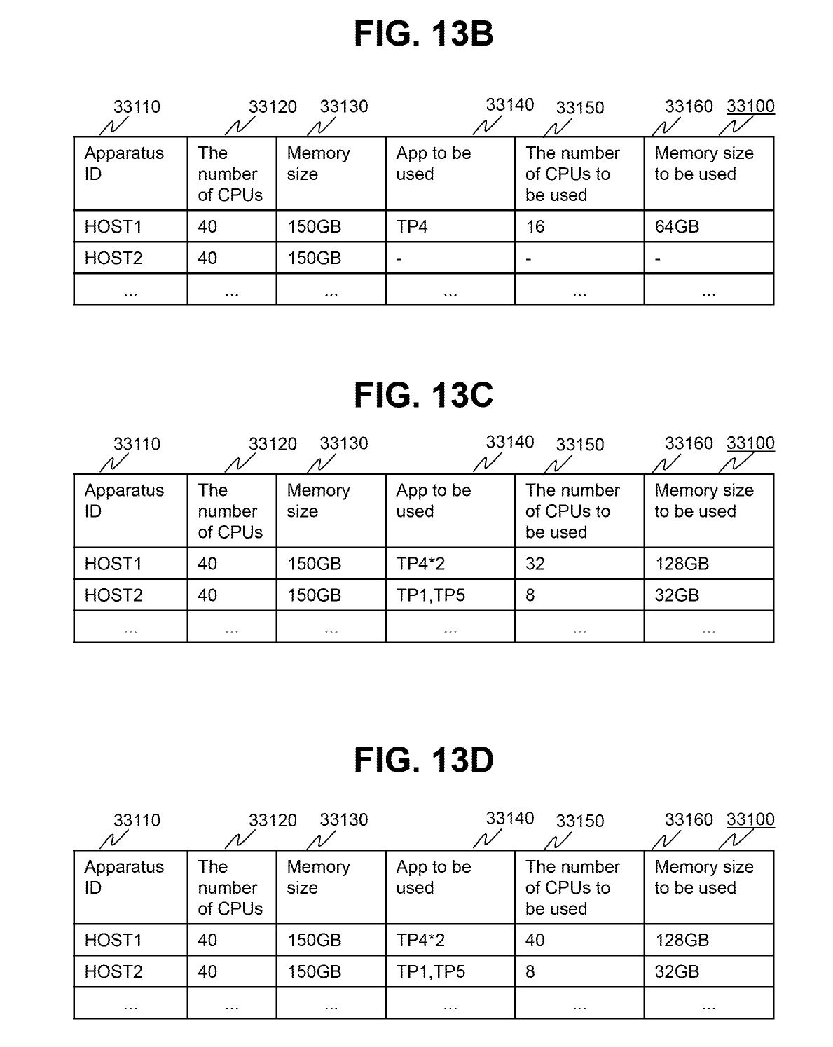

FIGS. 13A to 13D are diagrams showing configuration examples of the host management table 33100 in the management server 30000.

At least part of the host management table 33100 is an example of at least part of information included in the management information. The host management table 33100 includes information about the host computers. Specifically, for example, the host management table 33100 includes configuration items including: a field 33110 for registering the identifier of the host computer; a field 33120 for registering the number of processors (CPUs) included in the host computer; a field 33130 for registering the size of the memory included in the host computer; a field 33140 for registering information about the app to be constructed on the host computer; a field 33150 for registering the number of usable CPUs other than the app to be constructed in the host computer; and a field 33160 for registering the size of the usable memory other than the app to be constructed in the host computer.

According to FIG. 13A, the following can be stated, for example. The HOST1 includes forty processors (CPUs) and a memory of 150 GB.

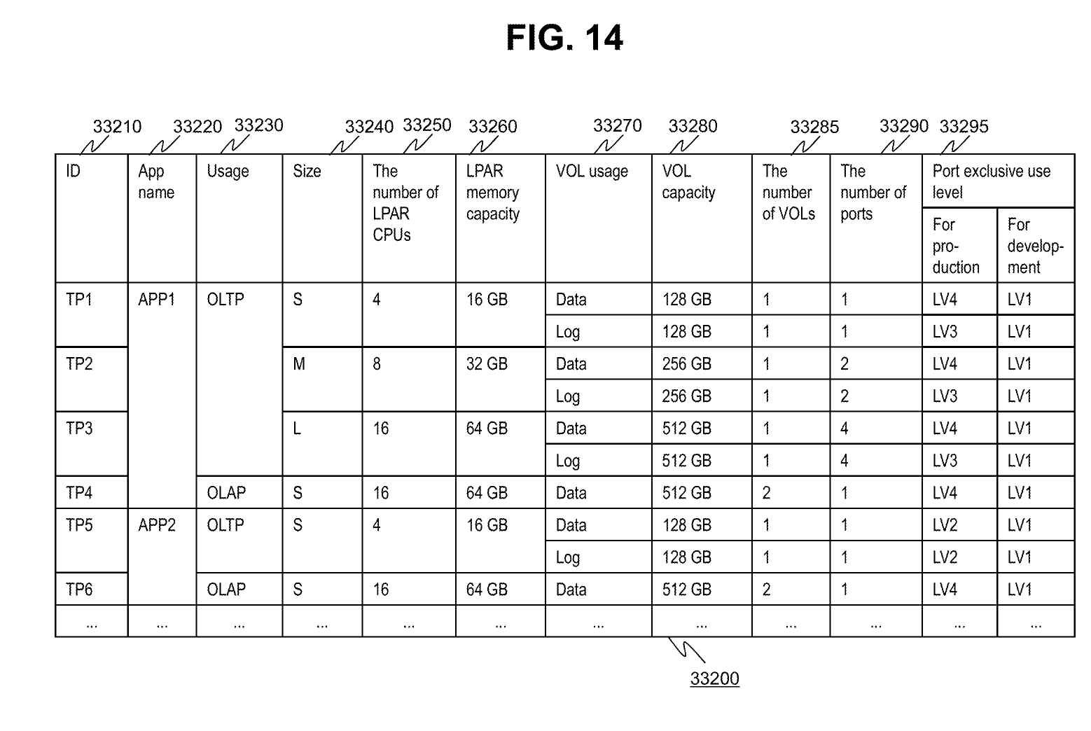

FIG. 14 is a diagram showing a configuration example of the template management table 33200 in the management server 30000.

At least part of the template management table 33200 is an example of at least part of the information included in the management information. The template management table 33200 includes information about templates of app requirements corresponding to app usages. Specifically, for example, the template management table 33200 includes configuration items including: a field 33210 for registering the identifier of the template designated when the manager constructs an app execution environment on the host computer and the storage apparatus; a field 33220 for registering the name of the app corresponding to the template; a field 33230 for registering the usage of the app corresponding to the template; a field 33240 for registering the size of the app corresponding to the template; a field 33250 for registering the number of CPUs necessary for constructing the app in the LPAR on the host; a field 33260 for registering the memory size necessary for constructing the app in the LPAR on the host; a field 33270 for registering the usage of the volume necessary for constructing the app; a field 33280 for registering the size of the volume; a field 33285 for registering the number of volumes; a field 33290 for registering the number of storage ports used to access the volumes necessary for constructing the app from the host; and a field 33295 for registering the exclusive use level of the storage port.

In the present embodiment, the term “app usage” may be defined by a combination of the purpose of processing, such as one of OLTP (Online Transaction Processing) and CLAP (Online Analytical Processing), the execution environment, such as one of the environment for production and the environment for development, the app name, and the app size. However, the definition of the term app usage is not limited to the definition, and the app usage may be defined by other methods. For example, part of the purpose of processing, the execution environment, the app name, and the app size may not be included. Furthermore, for example, other points of view may be adopted in place of or in addition to at least one of the purpose of processing, the execution environment, the app name, and the app size.

Furthermore, although the terms “app execution environment” and “LPAR” have the same meaning because the app and the OS are executed on the LPAR 15000 in the present embodiment, the LPAR is an example of the app execution environment. When the app and the OS are executed on the host computer 10000 without the involvement of the LPAR, the host computer 10000 is the app execution environment.

According to FIG. 14, the following can be stated, for example. The ID of the template for constructing an APP1 for OLTP in an S size is TP1. The app requirements indicated by the TP1 are as follows. More specifically, the LPAR that executes the APP1 for OLTP in the S size requires four CPUs and a memory of 16 GB for the APP1. Furthermore, for the APP1, the LPAR requires one volume of 128 GB for data and one volume of 128 GB for log. When the APP1 is for production, one storage port of exclusive use level LV4 is necessary for the volume for data, and one storage port of exclusive use level LV3 is necessary for the volume for log. When the APP1 is for development, one storage port of exclusive use level LV1 is necessary for each of the volume for data and the volume for log.

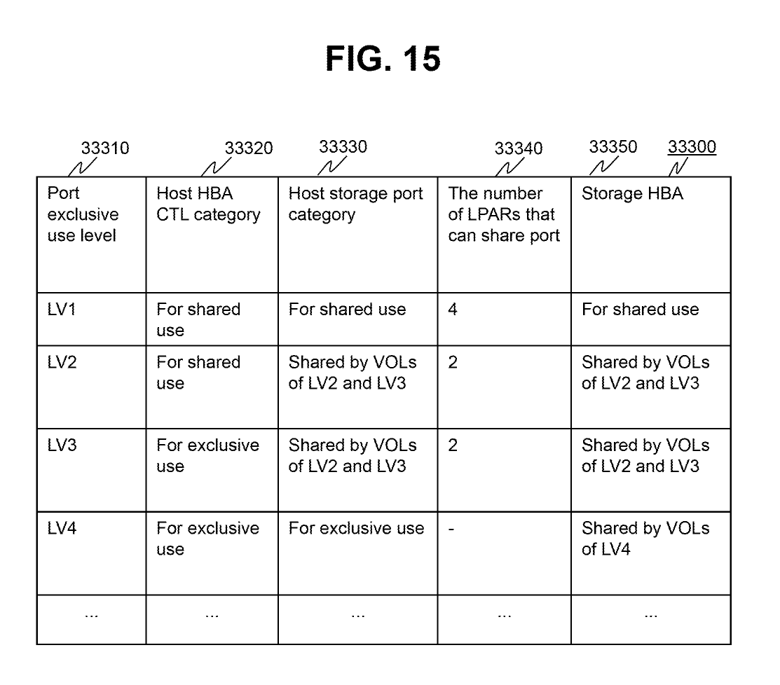

FIG. 15 is a diagram showing a configuration example of the storage port exclusive use level management table 33300 in the management server 30000.

At least part of the storage port exclusive use level management table 33300 is an example of at least part of the information included in the management information. The storage port exclusive use level management table 33300 includes information about the exclusive use level. Specifically, for example, the storage port exclusive use level management table 33300 includes configuration items including: a field 33310 for registering the identifier of the exclusive use level; a field 33320 for registering whether the controller on the host HBA in the exclusive use level needs to be exclusively used; a field 33330 for registering whether the host and the storage port in the exclusive use level need to be exclusively used; a field 33340 for registering the upper limit of the number of LPARs that share the host and the storage port in the exclusive use level; and a field 33350 for registering whether the storage HBA in the exclusive use level needs to be exclusively used. The term “exclusive use level” denotes a degree of exclusive use regarding the storage port, and specifically, the exclusive use level of the storage port may be defined by at least one of the following (a) to (d).

(a) The number of LPARs that can share the storage port.
(b) The allocation category (for exclusive use/for shared use) of the controller 14200 coupled to the server port coupled to the storage port.
(c) An attribute of the volume that can be associated with the storage port (for example, exclusive use level of another storage port associated with the volume as a resource for exclusive use or a resource for shared used).
(d) An attribute of the volume that can be associated with the storage HBA 21200 including the storage port.
In other words, the port usage mode corresponding to the exclusive use level may be defined by at least one of (a) to (d) described above.

According to FIG. 15, the following can be stated. The controller coupled to the server port (controller on the host HBA) coupled to the storage port of exclusive use level LV2 can be shared between the LPARs (resource for shared used). Furthermore, the storage port (and the server port coupled to the storage port) can be shared between the volumes associated with other storage ports of exclusive use level LV2 or LV3. The number of LPARs that can share the storage port of exclusive use level LV2 is two at most. The storage HBA including the storage port of exclusive use level LV2 can be shared only between the volumes associated with other storage ports of exclusive use level LV2 or LV3.

Note that the template management table shown in FIG. 14 and the storage port exclusive use level management table shown in FIG. 15 may be defined in advance as best practices by, for example, a higher manager (manager with sufficient knowledge about hosts or storages). The manager (higher manager or other managers) can designate, for the management server, the identifier of the template defined in the template management table 33200 to construct the app execution environment (LPAR) in the computer system.

Hereinafter, a process executed in the present embodiment will be described.

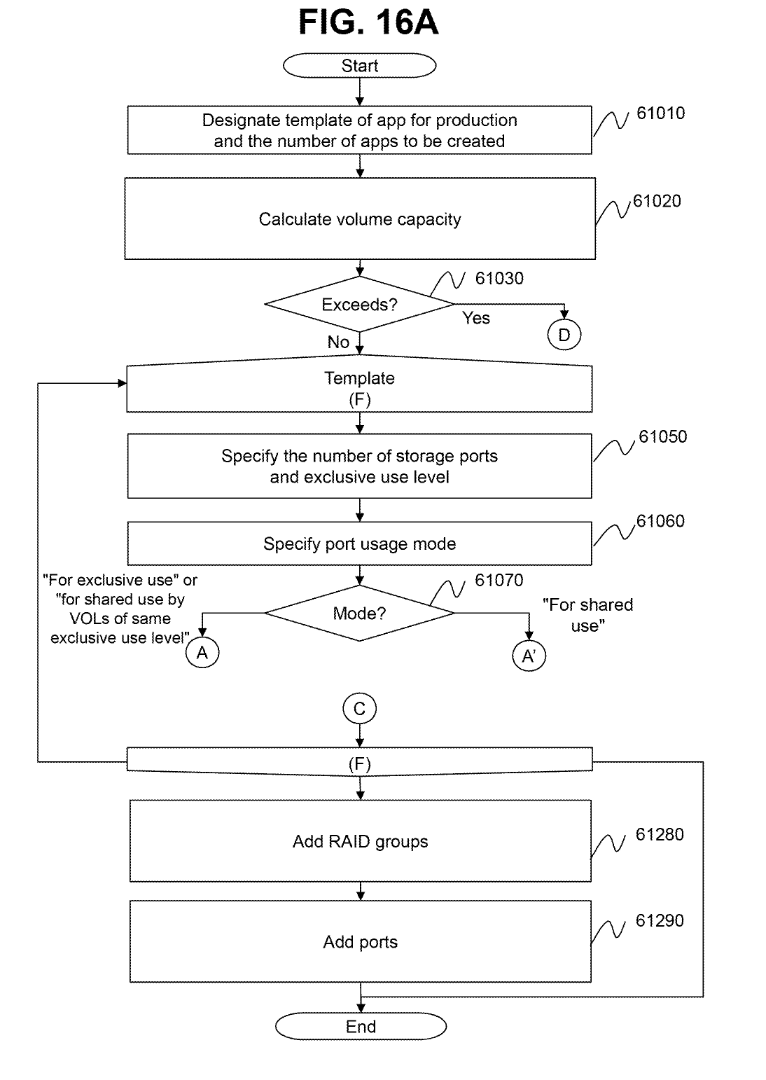

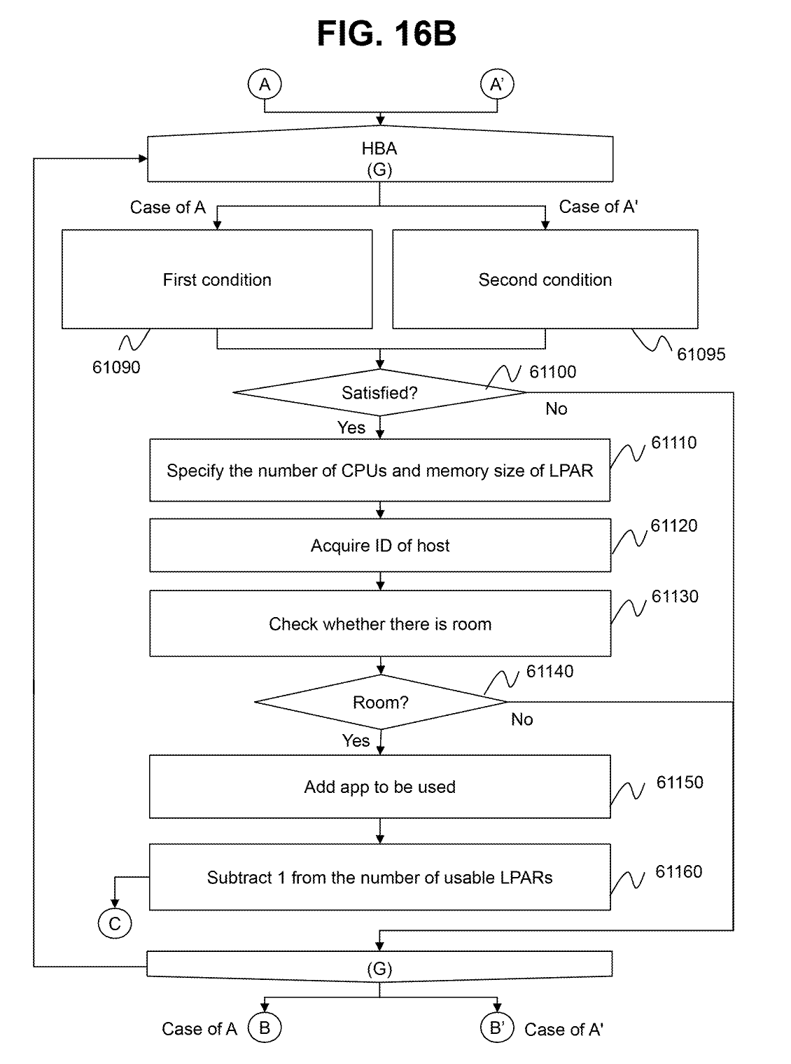

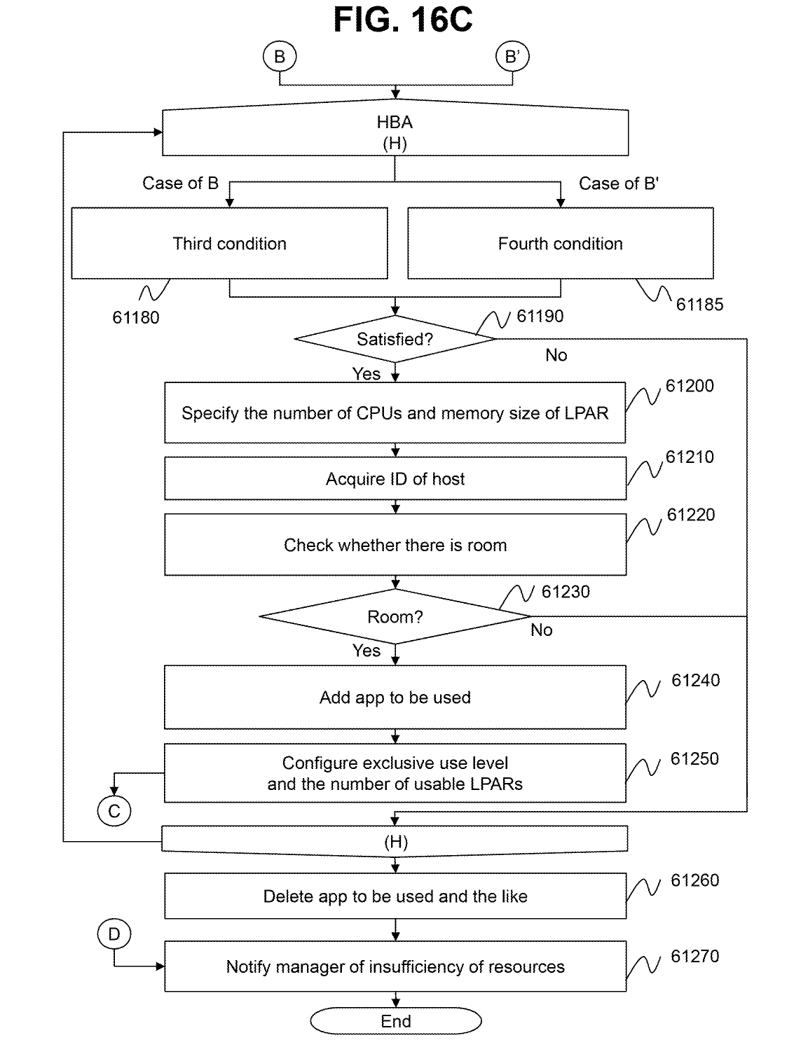

FIGS. 16A to 16C show a flow chart of a storage partition creation process.

The apparatus management module 32100 receives designation of the templates of apps to be constructed on the computer system and the number of apps from the manager through a GUI provided by the GUI display processing module 32300 (step 61010). The designated number of templates may be one or more. Furthermore, in the templates designated in step 61010, the app usage is an app usage including a usage for production. The number of apps may be designated for each of the designated templates, or the number of apps may be common to a plurality of designated templates. The designation of the templates denotes designation of the app usage. The templates may be designated by designation (input) of at least one of the template IDs and the app usages.

Next, the apparatus management module 32100 refers to the template management table 33200 to calculate the volume capacity necessary for constructing the apps with the designated app usage and the number of apps in accordance with the templates input by the manager in step 61010 (step 61020). The apparatus management module 32100 checks whether the calculated volume capacity exceeds the RAID group capacity of the entire storage apparatus (step 61030).

If the check result of step 61030 is affirmative (step 61030: Yes), the apparatus management module 32100 notifies the manager of the insufficiency of resources necessary for constructing the app execution environment through the GUI and ends the process (step 61270).

If the check result of step 61030 is negative (step 61030: No), the apparatus management module 32100 executes the following processing loop (F) for each template designated in step 61010. When a plurality of the same templates are designated, the following loop (F) is repeated for the number of times equivalent to the number of designated templates. Hereinafter, one template among the designated templates will be described as an example (referred to as “target template” in the description of FIGS. 16A to 16C).

The apparatus management module 32100 refers to the template management table 33200 and specifies the number of storage ports and the exclusive use level according to the app requirements corresponding to the target template (step 61050). Next, the apparatus management module 32100 refers to the storage port exclusive use level management table 33300 and specifies the port usage mode corresponding to the exclusive use level specified in step 61050 (step 61060). The apparatus management module 32100 determines whether the specified port usage mode is ““for exclusive use” or “for shared use between volumes of the same exclusive use level”” or “for shared use” (step 61070).

When the port usage mode specified in step 61060 is “for exclusive use” or “for shared use between volumes of the same exclusive use level”, the apparatus management module 32100 executes the following processing loop (G) for each HBA defined in the storage port management table 23200. Note that when the port usage mode specified in step 61060 is “for shared use”, step 61095 is executed in place of step 61090, and step 61185 is executed in place of step 61180 in the following processing loop (G). Hereinafter, one storage HBA 21200 will be described as an example (referred to as “target storage HBA (G)” in the description of the processing loop (G)).

The apparatus management module 32100 checks whether a first condition is satisfied (step 61090). The first condition is that the exclusive use levels of all the storage ports included in the target storage HBA (G) are the same as the exclusive use level specified in step 61050 and that the number of storage ports in which the number of usable LPARs is one or more is equal to or larger than the number (required number) of ports according to the target template. When the port usage mode specified in step 61060 is “for shared use”, the apparatus management module 32100 checks whether a second condition is satisfied (step 61095). The second condition is that the exclusive use level is the same as the exclusive use level specified in step 61050 in the target storage HBA (G) and that the number of storage ports in which the number of usable LPARs is one or more is equal to or larger than the number (required number) of ports specified in step 61050.

If the first or second condition is satisfied in the target storage HBA (G) (step 61100: Yes), the apparatus management module 32100 refers to the template management table 33200 and specifies the number of CPUs and the memory size necessary for creating the LPAR in the template specified in step 61040 (step 61110). Next, the apparatus management module 32100 refers to the storage port management table 23200 and acquires the ID of the host directly connected to the port specified in step 61090 (step 61120). Next, the apparatus management module 32100 refers to the host management table 33100 and checks whether there is a room for defining the LPAR with the specification specified in step 61110 on the host specified in step 61120 (step 61130).

If there is a room for defining the LPAR on the host (step 61140: Yes), the apparatus management module 32100 adds the number of required CPUs and the memory size specified in step 61110 to the number of CPUs to be used and the memory size to be used of the host specified in step 61120 in the host management table 33100, respectively, and adds the ID of the target template as an app to be used (step 61150). Next, the apparatus management module 32100 subtracts 1 from the number of usable LPARs for the port specified in step 61090 among the ports under the control of the HBA specified in step 61080 in the storage port management table 23200 (step 61160).

When the host scheduled to create the app (arrangement destination host of app) is not determined even at the end of the repeating process of the processing loop (G), the apparatus management module 32100 executes a processing loop (H) for each storage HBA defined in the storage port management table 23200. Hereinafter, one storage HBA 21200 will be described as an example (referred to as “target storage HBA (H)” in the description of the processing loop (H)).

The apparatus management module 32100 checks whether a third condition is satisfied (step 61180). The third condition is that all of the exclusive use levels of all of the storage ports included in the target storage HBA (H) are not designated and that the number of storage ports is equal to or larger than the number (required number) of ports for the template specified in step 61050. When the port usage mode specified in step 61260 is “for shared use”, the apparatus management module 32100 checks whether a fourth condition is satisfied (step 61185). The fourth condition is that the number of storage ports in which the exclusive use level is not designated is equal to or larger than the number (required number) of ports specified in step 61050 in the target storage HBA (H).

If the third or fourth condition is satisfied in the target storage HBA (H) (step 61190: Yes), the apparatus management module 32100 refers to the template management table 33200 and specifies the number of CPUs and the memory size necessary for creating the LPAR corresponding to the app usage specified in step 61040 (step 61200). Next, the apparatus management module 32100 refers to the storage port management table 23200 and acquires the ID of the host directly connected to the port specified in step 61180 (step 61210). Next, the apparatus management module 32100 refers to the host management table 33100 and checks whether there is a room for defining the LPAR with the specification specified in step 61200 on the host specified in step 61210 (step 61220).

If there is a room for defining the LPAR on the host (step 61230: Yes), the apparatus management module 32100 adds the number of required CPUs and the memory size specified in step 61200 to the number of CPUs to be used and the memory size to be used of the host specified in step 61210 in the host management table 33100, respectively, and adds the ID of the target template as an app to be used (step 61240). Next, the apparatus management module 32100 configures the exclusive use level and the number of usable LPARs for the port specified in step 61180 in the storage port management table 23200 (step 61250). When the port category corresponding to the exclusive use level of the port is “for exclusive use”, the apparatus management module 32100 sets the number of usable LPARs to “0” if the LPAR uses the port and sets the number of usable LPARs to “1” if the LPAR does not use the port. When the port category corresponding to the exclusive use level of the port is “for shared use”, the apparatus management module 32100 sets the number of usable LPARs to “a value subtracting 1 from the number of shareable LPARs corresponding to the exclusive use level of the port” if the LPAR uses the port and sets “the number of shareable LPARs corresponding to the exclusive use level of the port” as the number of usable LPARs if the LPAR does not use the port. After the execution of the process, the repeating process of step 61170 ends.

When the host scheduled to create the app is not determined even at the end of the processing loop (H), the apparatus management module 32100 deletes the number of CPUs to be used, the memory size to be used, and the app to be used of the host management table 33100 and deletes the exclusive use level and the number of usable LPARs of the storage port management table 23200 (step 61260). The apparatus management module 32100 then notifies the manager of the insufficiency of resources necessary for constructing the app through the GUI and ends the process (step 61270).

After the end of the repeating process of the processing loop (H), the apparatus management module 32100 defines the storage partitions for production and for development. In this case, the apparatus management module 32100 refers to the RAID group management table 23300 to add the RAID groups to the storage partition for production until the volume exceeds the volume capacity calculated in step 61020 and then adds the remaining RAID groups to the storage partition for development (step 61280). Next, the apparatus management module 32100 adds the ports, in which the exclusive use level is input, among the ports defined in the storage port management table 23200 to the storage partition for production and adds the ports, in which the exclusive use level is not input, to the storage partition for development (step 61290).

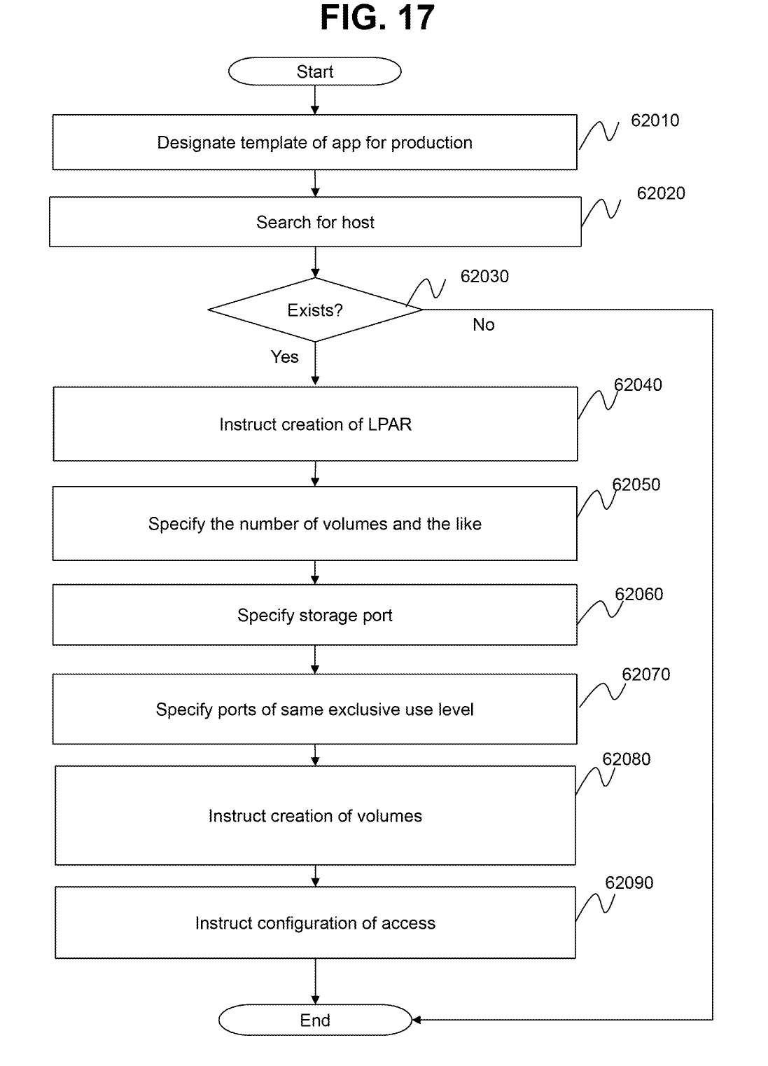

FIG. 17 shows a flow chart of a provisioning process of an app execution environment for production. The manager carries out the present provisioning process as needed once the app execution environment becomes necessary after the start of the operation after the end of the storage partition creation process. Note that for the app for development, the present flow chart is not used in the provisioning.

The apparatus management module 32100 receives designation of the template ID of the app for production to be constructed on the computer system from the manager through the GUI provided by the GUI display processing module 32300 (step 62010).

Next, the apparatus management module 32100 refers to the host management table 33100 and searches for the host including the app of the template input by the manager in the app to be created (step 62020). If the host does not exist (step 62030: No), the apparatus management module 32100 displays an error message to the manager through the GUI and ends the process.

If the host exists (step 62030: Yes), the apparatus management module 32100 refers to the template management table 33200 to check the specification of the LPAR necessary for the template specified by the manager in step 62010 and then instructs the host specified in step 62020 to create the LPAR (step 62040).

Next, the apparatus management module 32100 refers to the template management table 33200 and specifies the number of storage volumes, the size, the number of ports, and the exclusive use level necessary for the template specified in step 62010 (step 62050).

Next, the apparatus management module 32100 refers to the storage port management table 23200 and specifies the storage port directly connected to the host specified in step 62020 (step 62060). The apparatus management module 32100 then refers to the storage port management table 23200 and specifies the ports in which the exclusive use level is the same as the exclusive use level specified in step 62050 among the ports specified in step 62060 (step 62070).

Next, the apparatus management module 32100 refers to the storage partition management table 23600 and instructs the storage apparatus to configure and create volumes of the number and the size specified in step 62050 on the RAID group included in the storage partition for production (step 62080). The apparatus management module 32100 then instructs the storage apparatus to allow the LPAR created in step 62040 to access the volume created in step 62080 through the storage port specified in step 62070 (step 62090).

Hereinafter, how the storage partition is created and the provisioning is carried out in response to the input by the manager will be described as a specific example of Embodiment 1. However, it is assumed in the present embodiment that no information is registered in the LPAR management table included in the HOST1 or in the storage partition management table and the volume management table included in the SYS1 in the initial state. It is also assumed that the storage port management table included in the SYS1 is in the state of FIG. 8A, and the host management table included in the management server is in the state of FIG. 13A.

The apparatus management module receives designation of the templates of apps for production to be constructed on the computer system and the number of apps to be created from the manager through the GUI. In a case illustrated here, the manager has selected two templates indicated by the ID “TP4” (APP1-OLAP-S), one template indicated by the ID “TP1” (APP1-OLTP-S), and one template indicated by the ID “TP5” (APP2-OLTP-S) in the template management table shown in FIG. 14.

Next, the apparatus management module refers to the template management table to calculate the volume capacity necessary for constructing the apps according to the templates input by the manager and checks whether the volume capacity exceeds the RAID group capacity of the entire storage. With reference to the template management table shown in FIG. 14, the total required volume capacity is a sum of 1024 GB (TP4×2), 256 GB (TP1), and 256 GB (TP5) which is 1536 GB, and this is smaller than the total RAID group capacity of the RAID group management table shown in FIG. 9.

Next, the apparatus management module refers to the template management table and specifies the number of storage ports and the exclusive use levels necessary for the app usages defined in the templates designated by the manager. Next, the apparatus management module refers to the port requirement definition management table and specifies the port usage mode in the specified exclusive use level. For example, for the template TP4 (APP1-OLAP-5), with reference to the template management table shown in FIG. 14 and the port requirement definition management table shown in FIG. 15, one port is necessary, the HBA controllers of the host and the ports of the host storage need to be for exclusive use, and the storage HBA needs to be shared by volumes of the same exclusive use level LV4.

Next, the apparatus management module checks whether all of the exclusive use levels of all of the ports under the control of the HBA are LV4 for the HBA defined in the storage port management table. However, the HBA does not exist, and the apparatus management module checks whether all of the exclusive use levels of all of the ports under the control of the HBA are not designated for the HBA defined in the storage port management table. With reference to the storage port management table shown in FIG. 8A, the exclusive use levels of all of the ports under the control of the HBA indicated by the ID “HBA1” are not designated.

Next, the apparatus management module refers to the template management table and specifies the number of CPUs and the memory size of the LPAR defined in the template. With reference to the template management table shown in FIG. 14, sixteen CPUs and a memory of 64 GB are necessary for the template TP4 (APP1-OLAP-S). Next, the apparatus management module refers to the storage port management table and acquires the ID of the host directly connected to the port of the HBA. With reference to the storage port management table shown in FIG. 8A, the HOST1 is directly connected to the storage port indicated by the ID “PORT1” of the HBA1.

Next, the apparatus management module refers to the host management table and checks whether there is a room for defining the LPAR of the specification specified on the specified host. With reference to the host management table shown in FIG. 13A, it can be understood that the app to be used is not defined for the HOST1 yet, and the LPAR can be created in the HOST1 to access the storage through the PORT1 of the HBA1 of the SYS1.

Therefore, in the host management table, the apparatus management module adds the number of required CPUs of the TP4 and the memory size to the number of CPUs to be used of the host and the memory size to be used and adds the app to be used. Next, the apparatus management module configures the exclusive use levels in all of the ports under the control of the HBA1 that is the specified HBA in the storage port management table. As a result, the record of the first line in the host management table shown in FIG. 13B and the records of the first and second lines in the storage port management table shown in FIG. 85 are generated in response to the input by the user for operating the app for which the requirements are indicated by the template TP4 (APP1-OLAP-S).

As a result of repeating the process for the remaining one template indicated by the ID “TP4” (APP1-OLAP-S), one template indicated by the ID “TP1” (APP1-OLTP-S), and one template indicated by the ID “TP5” (APP2-OLTP-S) in the template management table, the records in the host management table shown in FIG. 13C and the records of the first to sixth lines in the storage port management table shown in FIG. 8B are eventually generated.

Subsequently, the apparatus management module defines the storage partitions for production and for development. In this case, the apparatus management module refers to the RAID group management table to add the RAID groups to the storage partition for production until the volume exceeds the calculated volume capacity and then adds the remaining RAID groups to the storage partition for development. Next, the apparatus management module adds the ports, in which the exclusive use level is input, among the ports defined in the storage port management table to the storage partition for production and adds the ports, in which the exclusive use level is not input, to the storage partition for development. As a result, the records of the first and second lines in the storage partition management table shown in FIG. 12 are generated.

The manager carries out the provisioning process as needed once the app execution environment becomes necessary after the start of the operation after the end of the storage partition creation process. First, the manager designates the template ID of the app for production to be constructed on the computer system through the GUI. In a case illustrated here, the manager has selected the template indicated by the ID “TP4” (APP1-OLAP-S) in the template management table shown in FIG. 14.

Next, the apparatus management module refers to the host management table and searches for the host including the app of the template input by the manager in the app to be created. With reference to the host management table shown in FIG. 13C, it can be understood that the TP4 is to be created on the HOST1.

Next, the apparatus management module refers to the template management table to check the specification of the LPAR in the template specified by the manager and then instructs the HOST1 to create the LPAR. With reference to the template management table shown in FIG. 14, sixteen CPUs and a memory of 64 GB are necessary for the TP4 (APP1-OLAP-S). As a result of instructing the HOST1 to create the LPAR, the record of the first line in the LPAR management table shown in FIG. 7A is generated.

Next, the apparatus management module refers to the template management table and specifies the number of storage volumes, the size, the number of ports, and the exclusive use level in the template specified by the manager. With reference to the template management table shown in FIG. 14, one port is necessary, the exclusive use level of the port is LV4, and the necessary volume capacity is 512 GB×2 for the TP4 (APP1-OLAP-S).

Next, the apparatus management module refers to the storage port management table and specifies the storage port directly connected to the host. The apparatus management module then refers to the storage port management table and specifies the port in which the exclusive use level is the same as the specified exclusive use level among the ports. With reference to the storage port management table shown in FIG. 8A, the PORT11 of the HOST1 and the PORT1 of the SYS1 are directly connected, and the exclusive use level is LV4.

Next, the apparatus management module refers to the storage partition management table and instructs the storage to configure and create volumes of the specified number and size on the RAID group included in the storage partition for production. The apparatus management module then instructs the storage SYS1 to allow the created LPAR to access the created volumes through the specified storage port PORT1. As a result of instructing the storage SYS1 to create the volumes and configure the path, the records of the first and second lines in the volume management table shown in FIG. 11A are generated.

### Embodiment 2

Embodiment 2 will be described. In this case, differences from Embodiment 1 will be mainly described, and the description will be omitted or simplified for the points in common with Embodiment 1.

In Embodiment 2, the apparatus management module 32100 executes an app requirement changing process.

In Embodiment 1, when the management server that manages the computer system receives an input of an app to be constructed on the server from the manager, the management server automatically creates a storage partition based on the templates defining the amount of resources necessary for each work. However, even when the LPARs of the server and the storage are created as in the template and the app is constructed it may be found in the actual operation of the app that the performance requirements of the app are not satisfied. Therefore, in general, the specification of the logical partition for constructing the app is changed after testing the performance and the like of the app in the test environment, and then the environment is migrated to the production environment. In this case, the balance between the storage partitions designed at the initial construction may be lost due to the change in the amount of resources allocated to each app, and as a result, the app integration rate in the server and the storage may be reduced.

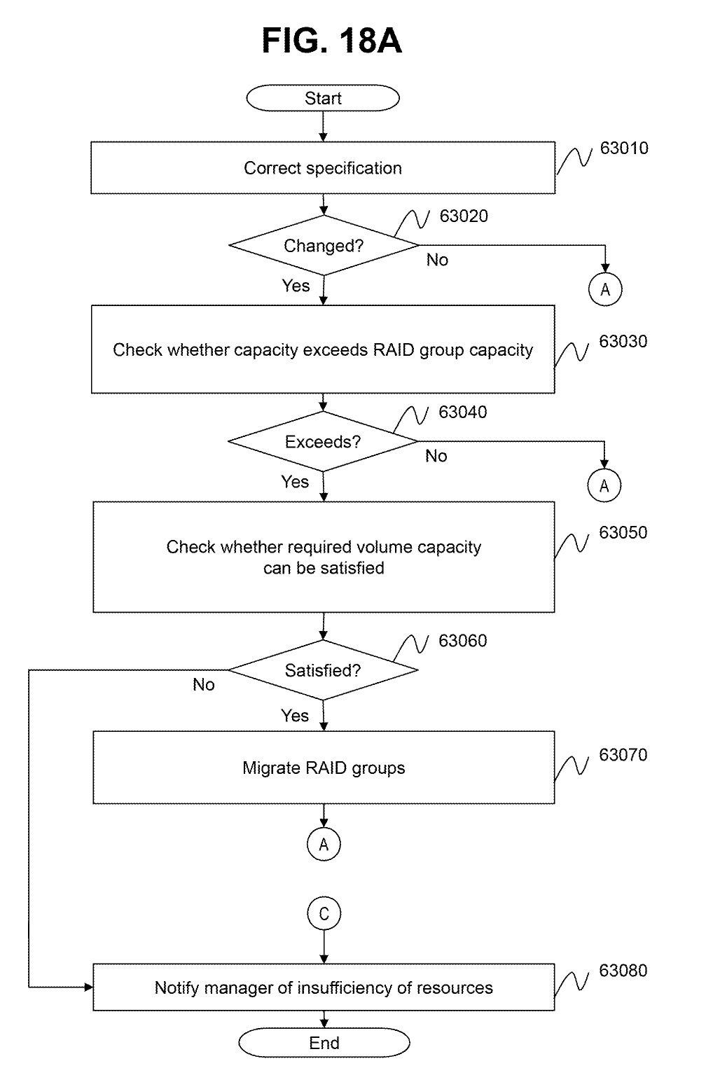

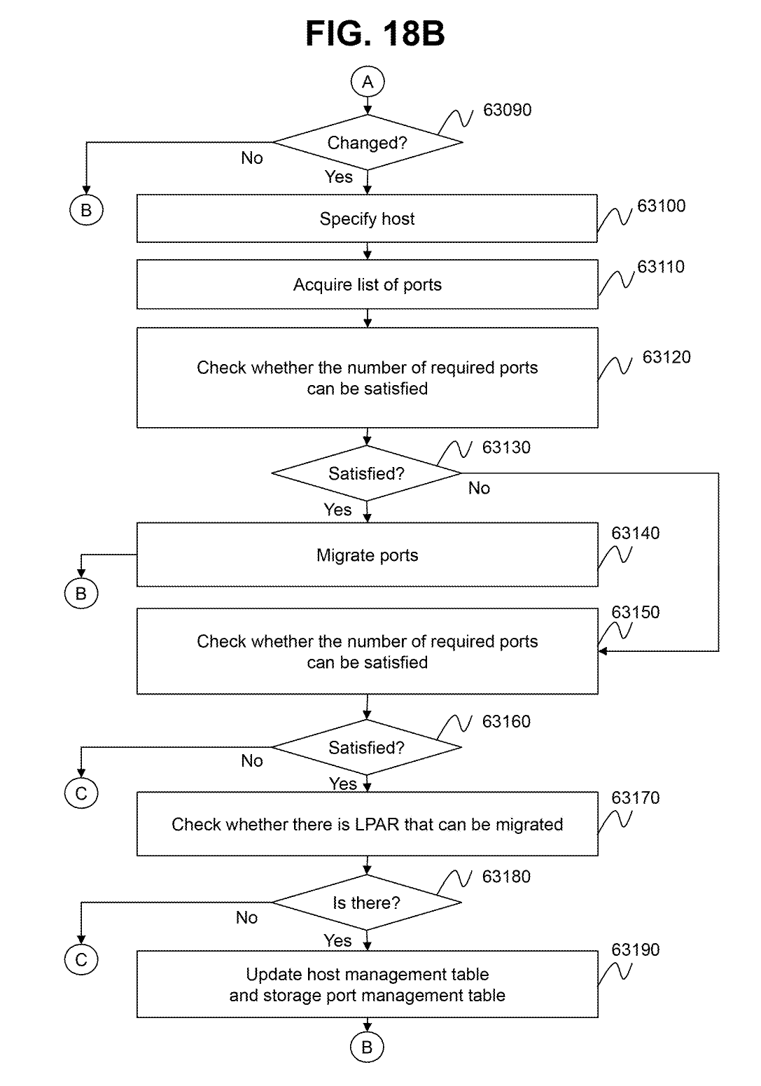

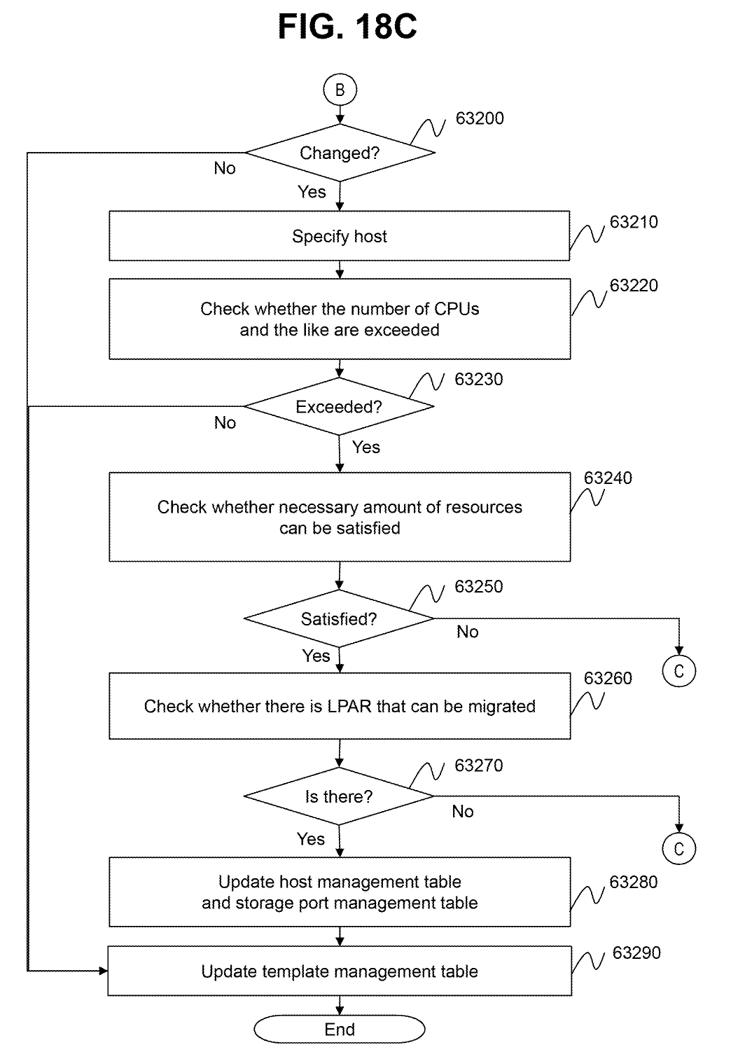

To solve such a problem, the management server 30000 newly carries out the app requirement changing process in Embodiment 2. FIG. 18 shows the app requirement changing process carried out by the apparatus management module 32100 of the management server 30000 in Embodiment 2. Note that the other points are identical or similar to Embodiment 1.

FIGS. 18A to 18C show a flow chart of the app requirement changing process.

The apparatus management module 32100 receives an input from the manager regarding correction of the specification required in the app for production to be constructed on the computer system through the GUI provided by the GUI display processing module 32300 (step 63010).

When the manager changes the capacity or the number of storage volumes required in the app in step 63010 (step 63020), the apparatus management module 32100 refers to the template management table 33200 and the host management table 33100 to calculate the volume capacity required in the app to be constructed on the host and checks whether the capacity exceeds the RAID group capacity of the storage partition for production (step 63030).

If the capacity does not exceed the RAID group capacity of the storage partition for production (step 63040: No), the process moves to step 63090. If the capacity exceeds the RAID group capacity (step 63040: Yes), the apparatus management module 32100 refers to the storage partition management table 23600 and the RAID group management table 23300 and checks whether the required volume capacity calculated in step 63030 can be satisfied by migrating the allocation destination of the unused RAID groups from the storage partition for development to the storage partition for production (step 63050).

If the required volume capacity cannot be satisfied (step 63060: No), the apparatus management module 32100 notifies the manager of the insufficiency of resources necessary for constructing the app through the GUI and ends the process (step 63080).

If the required volume capacity can be satisfied (step 63060: Yes), the apparatus management module 32100 migrates the unused RAID groups from the storage partition for development to the storage partition for production until the required volume capacity calculated in step 63030 is satisfied (step 63070).

Next, when the manager changes the number of ports required in the app in step 63010 (step 63090), the apparatus management module 32100 refers to the host management table 33100 and specifies the host scheduled to construct the app in which the number of ports is changed in step 63010 (step 63100). Next, the apparatus management module 32100 refers to the storage port management table 23200 and acquires a list of the ports directly connected to the host specified in step 63100 (step 63110).

Next, the apparatus management module 32100 refers to the storage partition management table 23600 and the storage port management table 23200 and checks whether the number of required ports can be satisfied by migrating the unused ports belonging to the storage partition for development among the ports specified in step 63110, from the storage partition for development to the storage partition for production (step 63120).

If the number of required ports can be satisfied (step 63130: Yes), the apparatus management module 32100 migrates the unused ports from the storage partition for development to the storage partition for production (step 63140).

If the number of required ports cannot be satisfied (step 63130: No), the apparatus management module 32100 refers to the storage partition management table 23600 and the storage port management table 23200 and checks whether the number of required ports can be satisfied by using the unused ports belonging to the storage partition for development among the ports of the host other than the ports specified in step 63110 (step 63150).

If the number of required ports cannot be satisfied (step 63160: No), the apparatus management module 32100 notifies the manager of the insufficiency of resources necessary for constructing the app through the GUI and ends the process (step 63080).

If the number of required ports can be satisfied (step 63160: Yes), the apparatus management module 32100 refers to the LPAR management table 13400 and the server port management table 13300 and checks whether there is an LPAR that can be migrated from the host specified in step 63100 to the host coupled to the unused port specified in step 63150 (step 63170). If there is no LPAR that can be migrated (step 63180: No), the apparatus management module 32100 notifies the manager of the insufficiency of resources necessary for constructing the app through the GUI and ends the process (step 63080).

If there is an LPAR that can be migrated (step 63180: Yes), the apparatus management module 32100 presents the manager with a plan for migrating the LPAR specified in step 63170 through the GUI and instructs the host and the storage to migrate the LPAR if the manager permits the plan. After the migration, the apparatus management module 32100 rewrites the host management table 33100 and the storage port management table 23200 according to the LPAR migration (step 63190).

Next, when the manager changes the number of CPUs or the memory size required in the app in step 63010 (step 63200), the apparatus management module 32100 refers to the host management table 33100 and specifies the host scheduled to construct the app in which the number of CPUs or the memory size is changed in step 63010 (step 63210). The apparatus management module 32100 then refers to the host management table 33100 and the LPAR management table 13400 and calculates the numbers of CPUs or the memory sizes required in the app for development constructed on the host and the app for production to be constructed on the host to check whether the numbers of CPUs or the memory sizes exceed the number of CPUs or the memory size of the host (step 63220).

If the numbers of CPUs and the memory sizes do not exceed the number of CPUs and the memory size of the host (step 63230: No), the process moves to step 63290.

If the numbers of CPUs or the memory sizes exceed the number of CPUs or the memory size of the host (step 63230: Yes), the apparatus management module 32100 refers to the host management table 33100 and the LPAR management table 13400 and checks whether the amount of resources necessary for defining the LPARs originally scheduled to be created can be satisfied by migrating part of the LPARs to a host other than the host specified in step 63210 (step 63240).

If the amount of required resources cannot be satisfied (step 63250: No), the apparatus management module 32100 notifies the manager of the insufficiency of resources necessary for constructing the app through the GUI and ends the process (step 63080).

If the amount of required resources can be satisfied (step 63250: Yes), the apparatus management module 32100 refers to the LPAR management table 13400 and the server port management table 13300 and checks whether there is an LPAR that can be migrated from the host specified in step 63210 to the host specified in step 63240 (step 63260). In this case, although the apparatus management module 32100 prioritizes the migration of the app for development, the app for production may be the migration target. If there is no LPAR that can be migrated (step 63270: No), the apparatus management module 32100 notifies the manager of the insufficiency of resources necessary for constructing the app through the GUI and ends the process (step 63080).

If there is an LPAR that can be migrated (step 63270: Yes), the apparatus management module 32100 presents the manager with a plan for migrating the LPAR specified in step 63260 through the GUI and instructs the host and the storage to migrate the LPAR if the manager permits the plan. After the migration, the apparatus management module 32100 rewrites the host management table 33100 and the storage port management table 23200 according to the LPAR migration (step 63280).

Lastly, the apparatus management module 32100 reflects the specification input by the manager in step 63010 on the template management table 33200 and ends the process (step 63290).

Hereinafter, an app requirement changing process as a specific example of Embodiment 2 will be described. However, it is assumed in the present embodiment that only the LPAR1 and the LPAR2 among the LPARs shown in FIG. 5 are not generated yet, the LPAR management tables of the HOST1 and the HOST2 are in the states shown in FIGS. 7C and 7B, the storage port management table is in the state shown in FIG. 8B, the volume management table is in the state of FIG. 11B, the storage partition management table is in the state of FIG. 12, and the host management table is in the state shown in FIG. 13G.

The apparatus management module receives an input regarding the correction of the specification required in the app for production to be constructed on the computer system from the manager through the GUI. In the case illustrated here, the manager has corrected the number of CPUs necessary for the LPAR from 16 to 20 regarding the template indicated by the ID “TP4” (APP1-OLAP-S) in the template management table shown in FIG. 14.

The apparatus management module refers to the host management table and specifies the host scheduled to construct the app in which the number of CPUs or the memory size is changed. With reference to the host management table shown in FIG. 13C, it can be understood that the host scheduled to construct the app by using the template indicated by the ID “TP4” in the template management table is the HOST1.

The apparatus management module then refers to the host management table and the LPAR management table and calculates the numbers of CPUs or the memory sizes required for the app for development constructed on the host and the app for production to be constructed on the host to check whether the numbers of CPUs or the memory sizes exceed the number of CPUs or the memory size included in the host. With reference to the host management table shown in FIG. 13C, it can be understood that the app for production to be constructed on the host requires thirty-two CPUs and a memory of 128 GB. Furthermore, with reference to the LPAR management table shown in FIG. 7C, it can be understood that the app for development constructed on the host requires four CPUs and a memory of 16 GB. However, the HOST1 includes only forty CPUs, and it can be understood that the number of CPUs becomes insufficient when the number of CPUs necessary in the TP4 is corrected from 16 to 20.

Next, the apparatus management module refers to the host management table and the LPAR management table and checks whether the amount of resources necessary for defining the LPARs originally scheduled to be created can be satisfied by migrating part of the LPARs to a host other than the host. With reference to the host management table shown in FIG. 13C, it can be understood that the app for production to be constructed on the host requires eight CPUs and a memory of 32 GB. Furthermore, with reference to the LPAR management table shown in FIG. 7A, it can be understood that the app for development constructed on the host requires four CPUs and a memory of 16 GB. Therefore, it can be understood that the insufficiency of the number of CPUs of the HOST1 can be eliminated by migrating the LPAR3 that is an LPAR created for development on the HOST1 to the HOST2.

Next, the apparatus management module refers to the LPAR management table and the server port management table and checks whether there is an LPAR that can be migrated from the host to the specified host. With reference to the storage port management table shown in FIG. 8B, the LPAR3 on the HOST1 can be migrated to the host HOST2 by using the PORT24 that is a port belonging to the storage partition for development of the HOST2.

Next, the apparatus management module presents the manager with a plan for migrating the LPAR through the GUI and instructs the host and the storage to migrate the LPAR if the manger permits the plan. After the migration, the apparatus management module rewrites the host management table and the storage port management table according to the LPAR migration. As a result of instructing the HOST1 and the HOST2 to migrate the LPAR and rewriting the host management table and the storage port management table according to the LPAR migration, the LPAR management table of the HOST2 is in the state without a record, the LPAR management table of the HOST2 is in the state shown in FIG. 7D, the storage port management table is in the state of FIG. 8C, the volume management table included in the storage SYS1 is in the state of FIG. 11C, and the host management table is in the state of FIG. 13D.

Lastly, the specification input by the manager is reflected on the template management table, and the process ends.

### Embodiment 3

Embodiment 3 will be described. In this case, differences from Embodiments 1 and 2 will be mainly described, and the description will be omitted or simplified for the points in common with Embodiments 1 and 2.

In Embodiment 3, another storage partition creation process and an app requirement changing process carried out by the apparatus management module 32100 of the management program will be described.

In recent years, a computer system in a mode called a hyper-converged infrastructure is becoming popular. This is a computer system integrating a plurality of host computers and constructing virtual storages by built-in disks of the hosts without physical storages for shared use. In the computer system, an app on a host frequently accesses the built-in disk of an adjacent host. Therefore, hosts are generally coupled through a dedicated high-speed line to speed up the disk access. However, there is usually an upper limit in the number of hosts that can construct the virtual storages. The hosts not sharing the virtual storages are coupled through an IP network via an IP switch.

In that case, accessing the virtual storages not existing on the host by the LPAR on the host needs to be prevented as much as possible. This is because the hosts not sharing the virtual storages perform communications through a non-dedicated IP network, and the speed of volume access from the LPAR is significantly reduced compared to when the virtual storages are shared.

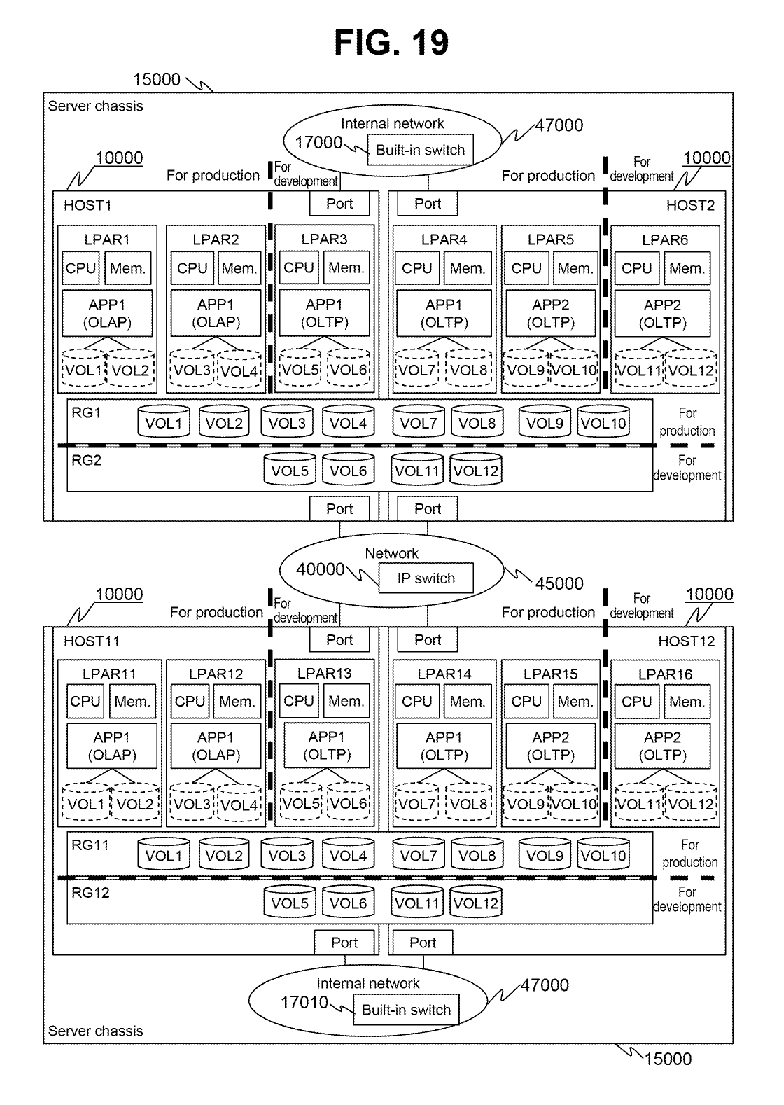

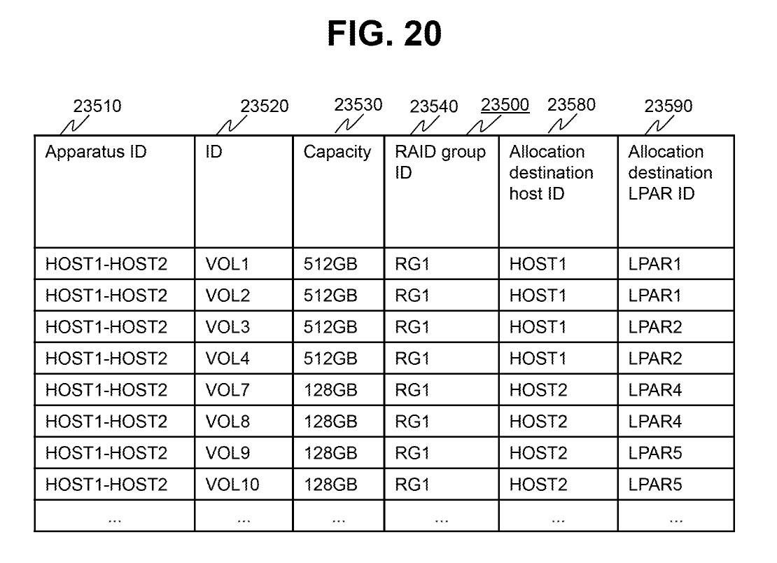

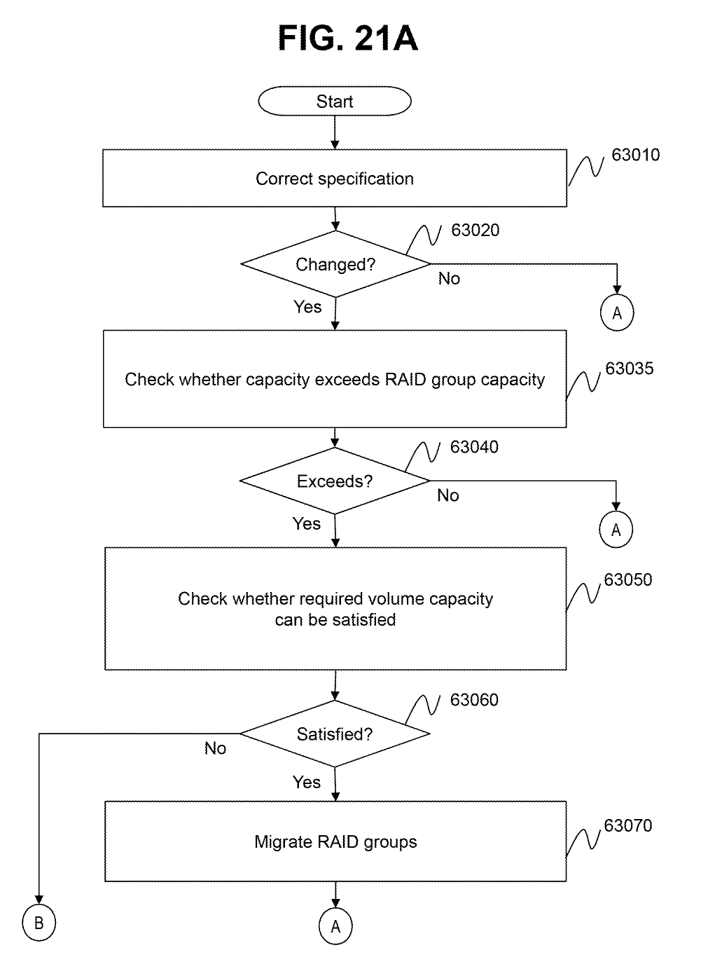

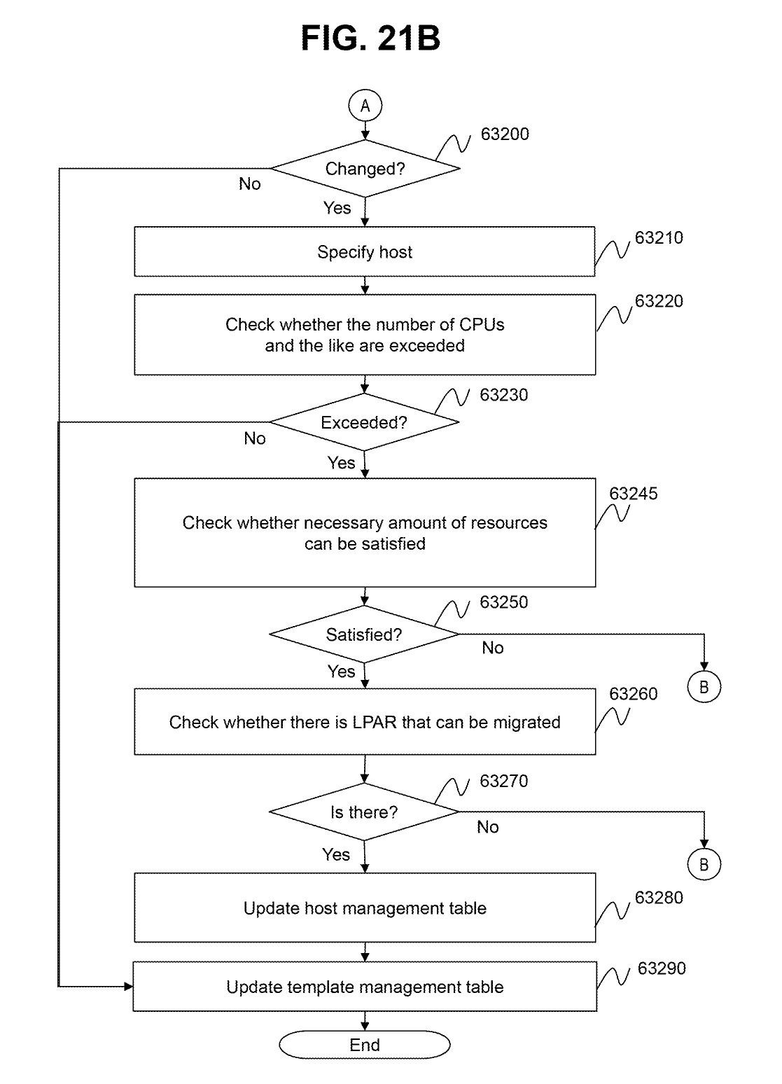

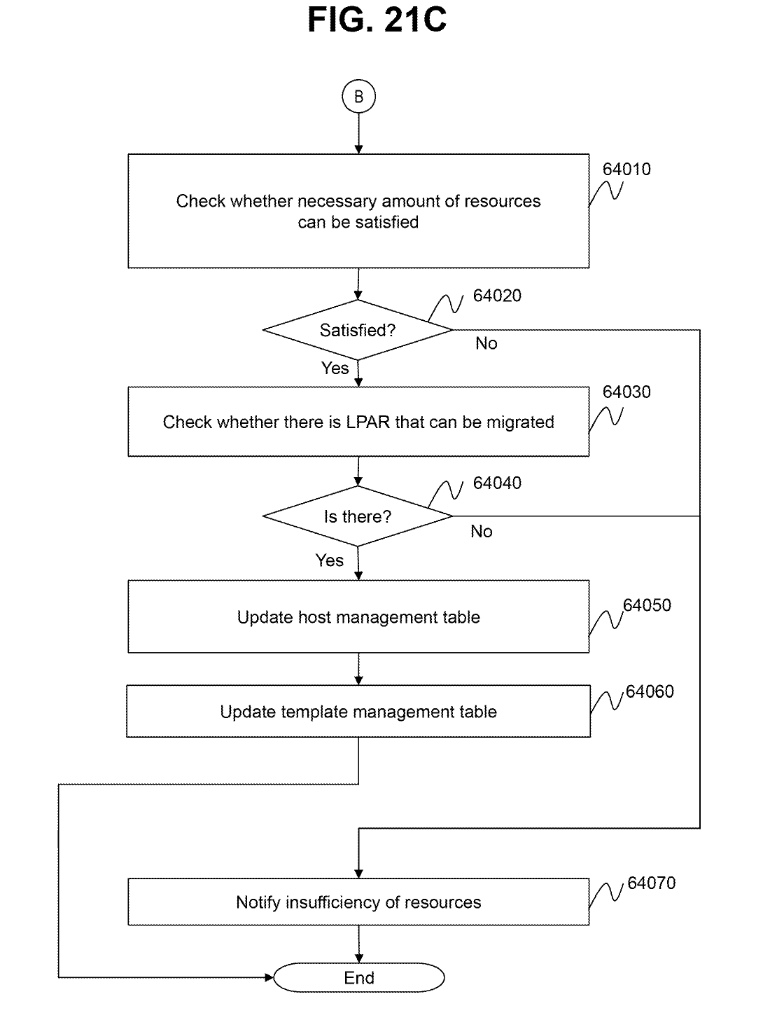

To solve the problem, the other storage partition creation process and the app requirement changing process in the management server 30000 are changed in Embodiment 3. FIG. 19 shows a configuration of the computer system and a configuration of apparatuses coupled to the computer system according to Embodiment 3. FIG. 20 shows management information newly included in the management server in Embodiment 3. FIG. 21 shows a conceptual diagram of an app requirement changing process carried out by the management server 30000.

Note that the server port management table 13300, the storage port management table 23200, the CLPR management table 23400, and the storage port exclusive use level management table 33300 in Embodiments 1 and 2 do not exist in the present embodiment, and the RAID group management table 23300 is stored on the management memory 13000 of the host computer 10000. Furthermore, the information equivalent to the record 13450 and the record 13460 does not exist in the LPAR management table 13400, and only the CPUs and the memory are allocated to each LPAR. Furthermore, the information equivalent to the record 23630, the record 23650, and the record 23660 does not exist in the storage partition management table 23600, and only the RAID group is allocated to each storage partition. The allocation of the RAID group to each storage partition and the app for production to be created in each host are manually determined by the manager or determined in advance in the process by the management server 30000 equivalent to the storage partition creation process shown in FIG. 16. In this case, the LPARs and the volumes need to be arranged such that the LPARs on the host do not access the virtual storages not existing on the host.

FIG. 19 is a diagram showing a configuration example of coupling of the host computers 10000 and the storage apparatus 20000.

The I/O ports of the host computers 10000 stored in the chassis 15000 are coupled to each other through the internal network 47000 constructed by the built-in IP switch 17000. Similarly, I/O ports of host computers 10020 stored in a chassis 15000 are also coupled to each other through an internal network 47010. Although the I/O ports of the host computers and the storage are coupled through the built-in switch 17000 in the present embodiment, it is only necessary that the I/O ports of the host computers be coupled to each other, and the I/O ports may be coupled through another medium, such as a PCIe bus and an FC cable. On the other hand, the port of the HOST1, and the ports of the HOST2, the HOST11, and the HOST12 are coupled through the network 45000 via the IP switch 40000. Furthermore, a plurality of storage units of the HOST1 and the HOST2 in the same server chassis may be used to constitute one or a plurality of RAID groups. Similarly, a plurality of storage units of the HOST11 and the HOST12 in the same server chassis may be used to constitute one or a plurality of RAID groups.

FIG. 20 is a diagram showing a configuration example of the volume management table 23500 in the host 10000.

The volume management table 23500 includes configuration items including: the field 23510 for registering the identifier of the host including the volume; the field 23520 for registering the volume ID that is the identifier of each volume in the host; the field 23530 for registering the capacity of each volume; the field 23540 for registering the RAID group ID that is the identifier of the RAID group to which each volume belongs; a field 23590 for registering the ID of the allocation destination LPAR of each volume; and a field 23580 for registering the ID of the host including the allocation destination LPAR.

According to FIG. 20, the following can be stated. The VOL1 exists across the HOST1 and the HOST2. The capacity of the VOL1 is 512 GB. The VOL1 belongs to the RG1. The VOL1 is allocated to the LPAR1 on the HOST1.

FIG. 21 shows a flow chart of the app requirement changing process according to Embodiment 3. Compared to Embodiment 1, the process of step 63030 is changed to a process of step 63035, and the process of step 63240 is changed to a process of step 63245 in Embodiment 3. The process from step 63080 to step 63190 is deleted, and a process from step 64010 to step 64070 is added. Hereinafter, only the changed processes will be described.

If the manager changes the capacity or the number of storage volumes required in the app in step 63010 (step 63020: Yes), the apparatus management module 32100 refers to the template management table 33200 and the host management table 33100 to calculate the volume capacity required in the app to be constructed on the host and checks whether the volume capacity exceeds the RAID group capacity of the storage partition for production (step 63035).

If the numbers of CPUs or the memory sizes exceed the number of CPUs or the memory size of the host in step 63230 (step 63230: Yes), the apparatus management module 32100 refers to the host management table 33100 and the LPAR management table 13400 and checks whether the amount of resources necessary for defining the LPARs originally scheduled to be created can be satisfied by migrating part of the LPARs to a host other than the host specified in step 63210 (step 63245).

If the amount of required resources cannot be satisfied in step 63060 or step 63250 or if there is no LPAR that can be migrated in step 63270, the apparatus management module 32100 refers to the host management table 33100 and the LPAR management table 13400 and checks whether the amount of resources necessary for defining the LPARs to be originally scheduled to be created can be satisfied by migrating part of the LPARs to a host that does not share the same virtual storage as the host specified in step 63030 or step 63210 (step 64010).

If the amount of required resources cannot be satisfied (step 64020: No), the apparatus management module 32100 notifies the manager of the insufficiency of resources necessary for constructing the app through the GUI and ends the process (step 64070).

If the amount of required resources can be satisfied (step 64020: Yes), the apparatus management module 32100 refers to the LPAR management table 13400 and the server port management table 13300 and checks whether there is an LPAR that can be migrated from the host specified in step 63030 or step 63210 to the host specified in step 64010 (step 64030). In this case, the apparatus management module 32100 preferentially selects the LPAR provided with the app for development or the LPAR provided with the app with a low frequency of access to the volume. If there is no LPAR that can be migrated (step 64040: No), the apparatus management module 32100 notifies the manager of the insufficiency of the resources necessary for constructing the app through the GUI and ends the process (step 64070).

If there is an LPAR that can be migrated (step 64040: Yes), the apparatus management module 32100 presents the manager with a plan for migrating the LPAR specified in step 64030 through the GUI and instructs the host and the storage to migrate the LPAR if the manager permits the plan. After the migration, the apparatus management module 32100 rewrites the host management table 33100 and the storage port management table 23200 according to the LPAR migration (step 64050).

Lastly, the specification input by the manager in step 63010 is reflected on the template management table 33200, and the process ends (step 64060).

Hereinafter, embodiments will be summarized. Note that in the description of the summary, new descriptions, such as modifications of embodiments, can be appropriately added.

The management server 30000 (or the system including the management server 30000 and the WEB-browser launching server 35000) is an example of a management system for a computer system including a plurality of resources. The management server 30000 includes: the management port 31000 coupled to the computer system; the storage unit 33000 that stores the management information (33100 to 33400) that is information including information about the plurality of resources; and the processor 31100 coupled to the management port 31000 and the storage unit 33000. The plurality of resources include a plurality of logical volumes and a plurality of computer resources including a plurality of kinds of computer resources. The computer system includes a host system including two or more computer resources of the plurality of computer resources. The processor 31100 executes the management program 32000. The management program 32000

(A) receives designation of the app (application program) usage from the manager,
(B) refers to the management information, and
(C) for the target LPAR 15000 that is the LPAR 15000 for executing the app of the designated app usage, determines at least one of the specification of resources allocated for exclusive use and the specification of resources allocated for shared use in accordance with the app requirements associated with the designated app usage. The specification of resources includes at least one of the kind of resources, the app usage associated with the resources, and the number of resources.

The designation in (A) is change designation that is one of designation associated with the app requirements after change regarding the designated app usage among the plurality of app usages (for example, combinations of information elements in the fields 33220, 33230, and 33240) indicated in the template management table 33200 included in the management information and designation associated with the number of apps after change regarding the designated app usage. When resources regarding at least one same kind of resources are insufficient due to the change according to the change designation, the determination in (C) is determination of adding the insufficient resources for the target LPAR 15000. The computer system includes a plurality of subsystems obtained by logical partitioning from a host system to a plurality of logical volumes. A first subsystem of the plurality of subsystems is a production system that is a subsystem belonging to the production environment. A second subsystem of the plurality of subsystems is a development system that is a subsystem belonging to the development environment. When resources regarding at least one same kind of resources are insufficient due the change according to the change designation, the determination in (C) is determination of adding the insufficient resources from the development system regarding the target LPAR 15000 in the production system.

A pool that is a set of one or more logical volumes is allocated to the target LPAR 15000. In the computer system, a storage area is allocated from the pool allocated to the target LPAR 15000 to a virtual volume designated by a write request from the target LPAR 15000. When the same kind of resources are logical volumes, the determination in (C) is determination of adding the logical volumes of the insufficient capacity from the development system to the pool allocated to the target LPAR 15000. The computer system includes two or more host systems including first and second host systems coupled through a communication network. The target LPAR 15000 is in the first host system. The determination in (C) is determination of performing allocation of at least one of allocation for exclusive use and allocation for shared use of the resources in at least one of the two or more host systems regarding the target LPAR 15000. Each of the first and second host systems includes one or more logical volumes based on one or more storage devices included in the host system. When the logical volumes are insufficient in the first host system regarding the target LPAR 15000, the determination in (C) is determination of allocating the logical volumes of the second host system regarding the target LPAR 15000 and determination of migrating the target LPAR 15000 from the first host system to the second host system.

The computer system includes a host system and a storage system. The host system includes the plurality of host computers 10000 including the plurality of ports 14000. The storage system includes: the plurality of ports 21000 coupled to the plurality of ports 14000; and a plurality of logical volumes. The plurality of resources include the plurality of ports 14000 and the plurality of ports 21000. The coupling relationship between the ports 14000 and the ports 21000 is a one-to-one relationship. The app usage is associated with at least one of the ports 14000 and the ports 21000. For each of the plurality of LPARs 15000 provided with a plurality of computer resources included in the plurality of host computers 10000, at least one of the ports 14000 and the ports 21000 allocated for exclusive use or allocated for shared use to the LPAR 15000 is a port associated with the same app usage as the app usage of the app executed by the LPAR 15000. When the designation in (A) is the change designation and the computer resources regarding at least one same kind of computer resources are insufficient due to the change according to the change designation, the determination in (C) is determination of adding, for the target LPAR 15000, the insufficient computer resources from the target host computer 10000 that is the host computer 10000 executing the LPAR 15000. When the same kind of computer resources are the ports 14000, the determination in (C) is determination of changing the app usage associated with at least one port of the ports 14000 of the target host computer 10000 and the ports 21000 coupled to the ports 14000 to the app usage designated in (A). If the computer resources of the target host computer 10000 become insufficient when the insufficient resources are added for the target LPAR 15000 from the target host computer 10000, the determination in (C) is determination (x1) of migrating the LPAR 15000 from the target host computer 10000 to the host computer 10000 of the migration destination and determination (x2) of associating the app usage of the app executed by the LPAR 15000 with at least one port of the ports 14000 of the host computer 10000 at the migration destination and the ports 21000 coupled to the ports 14000. Each of the production system and the development system includes at least part of the plurality of host computers 10000, the designation in (A) is designation associated with the app requirements after the change, and when the computer resources regarding at least one same kind of computer resources are insufficient between the app requirements after the change and the app requirements before the change, and the resources are insufficient even if the insufficient resources are added from the development system to the target LPAR 15000, the determination in (C) is the determination of (x1) and (x2).

The designation in (A) may be designation associated with a set of the app usage and the number of apps, and the determination in (C) may be determination of the specification of resources regarding each of the plurality of target LPARs 15000 that execute a plurality of apps according to the designated app usage and the number of apps. In (C), the management program 32000 (c1) logically partitions the storage system and (c2) determines the specification of resources allocated from the plurality of host computers 10000 for each of the plurality of target LPARs 15000 after (c1). In (c1), the management program 32000 associates, with the port 21000, the app usage without the insufficiency of resources even if the specification of target computer resources is allocated from the host computer 10000 including the port 14000 coupled to the port 21000 among the designated app usages. The specification of target resources is a specification of computer resources regarding the host system among the specifications of resources according to the app requirements corresponding to the associated app usage. Once the storage partitions are created (once the storage system is logically partitioned), changing the storage partitions becomes troublesome. For example, to move the RAID group 24000 to another storage partition, the data on the RAID group needs to be migrated, and therefore, a large load is imposed on the storage apparatus 20000. Thus, it is preferable to define the storage partitions in advance before the start of the operation after somewhat envisioning what kind of work (app) will be brought onto the host system (host computer 10000).

The management program 32000 is configured to execute the initial arrangement process of the LPARs 15000 including (A) to (C) and the resource allocation changing process including (A) to (C).

In the initial arrangement process of the LPARs 15000, the designation in (A) is designation associated with the set of the app usage and the number of apps. The determination in (C) is determination of the specification of resources for each of the plurality of target LPARs 15000 that execute the plurality of apps according to the designated app usage and the number of apps.

In the resource allocation changing process, the designation in (A) is change designation of at least one of designation associated with the app requirements after the change regarding the designated app usage among the plurality of app usages indicated in the template management table 33200 and designation associated with the number of apps after the change regarding the designated app usage. The determination in (C) is determination of changing the specification of resources of the target LPAR 15000 in accordance with the change designation.

In the description, the management program 32000 can specify the correspondence between the storage ports and the app usages by referring to the information acquired from the LPAR management table 13400 (for example, information acquired from the fields 13450 to 13470) and the information acquired from the storage port management table 23200 (for example, information acquired from the fields 23240 to 23270) in the management information (33100 to 33400).

The resource allocation is performed by the management program of the management server based on the management information stored in the management server. Specifically, for example, the management program can receive designation of the app usage from the manager to realize at least one of the following (example 1) to (example 8) based on the designated app usage and the management information. In other words, the management information is information configured to allow realizing at least one of the following (example 1) to (example 8).

### Example 1

In each of two or more LPARs, an app that issues an I/O request for logical volumes provided by the storage apparatus is executed. In each of the two or more LPARs, load characteristics of the LPAR are I/O characteristics that are characteristics of I/O for the logical volumes provided to the LPAR.

### Example 2

In (example 1), in each of the two or more LPARs, the I/O characteristics of the LPAR include an I/O size that is the size of I/O target data associated with the I/O request issued by the LPAR.

### Example 3

In (example 1), in each of the two or more LPARs, the I/O characteristics of the LPAR are characteristics determined based on input of the usage of the app executed by the LPAR and input of the usage of the logical volumes by the app at the I/O destination.

### Example 4

In any of (example 1) to (example 3), the plurality of server resources include one or more controllers (CTLs) of one or more first interface devices (for example, server HBAs) coupled to the storage apparatus and one or more server ports of the one or more first interface devices. The plurality of storage resources include one or more second interface devices coupled to the host and one or more storage ports of the one or more second interface devices (for example, storage HBAs). For at least one of the CTLs, the server ports, the second interface devices, and the storage ports, whether to perform the allocation for exclusive use or the allocation for shared use in each of the two or more LPARs depends on the I/O size of the logical volumes provided to the LPAR.

### Example 5

In (example 4), for the LPAR provided with two or more logical volumes determined to have a large I/O size, different CTLs, different server ports, and different storage ports are allocated, and the second interface devices are allocated for shared use. The second interface devices allocated for shared use are shared by the LPAR provided with logical volumes of the same I/O size.

### Example 6

In (example 4) or (example 5), different CTLs and different second interface devices are allocated to the LPAR provided with logical volumes determined to have a large I/O size and to the LPAR provided with logical volumes determined to have a small I/O size.

### Example 7

In (example 4), different CTLs are allocated to two or more LPARs provided with logical volumes determined to have a small I/O size, and the server ports, the storage ports, and the second interface devices are allocated for shared use. The second interface devices and the storage ports allocated for shared use are shared by the LPARs provided with logical volumes of the same I/O size.

### Example 8

The computer system includes a plurality of subsystems obtained by logical partitioning from the host to the storage apparatus. A first subsystem of the plurality of subsystems is a production system that is a subsystem belonging to the production environment. A second subsystem of the plurality of subsystems is a development system that is a subsystem belonging to the development environment. The production system includes two or more LPARs.

Although some embodiments have been described, the embodiments are illustrated for the description of the present invention, and the embodiments are not intended to limit the scope of the present invention only to the embodiments. The present invention can also be carried out in various other modes.

Furthermore, the computer system may be a system including a server apparatus determined in advance to play a role of a server and a storage apparatus determined in advance to play a role of a storage (or a storage controller). The computer system may be a system including a plurality of computers for which the roles are not determined in advance, and the manager sets the role of each computer to one or both of a server and a storage (storage controller). When the computer plays roles of both the server and the storage, part of the resources of the computer is used as server resources, and other part of the resources of the computer is used as storage resources.

Furthermore, according to the embodiments (for example, FIG. 5), a plurality of kinds of resources respectively corresponding to a plurality of consecutive tiers are logically partitioned (allocated and controlled) in the logical partitioning from the server system to the plurality of logical volumes and in the logical partitioning based on at least one of the I/O characteristics, the app usage, and the like (for example, logical partitioning of the production system). However, the plurality of tiers may not be strictly consecutive in the logical partitioning. For example, even when first and second resources are resources of the kinds that can be logically partitioned, a third resource between the first and second resources in the tiers may be a resource of the kind that cannot be logically partitioned. In this case, the resource in the middle is not logically partitioned in the logical partitioning from higher to lower resources. However, such a case can also be substantially called logical partitioning from higher to lower resources (for example, logical partitioning from a server system to a plurality of logical volumes). Note that whether the logical partitioning is possible or impossible may depend on at least one of the kind of resources and the function of storage system.

### REFERENCE SIGNS LIST

10000: host computer, 15000: server chassis, 20000: storage apparatus, 30000: management server, 35000: WEB-browser launching server, 40000: IP switch, 45000: network, 46000: PCIe bus

1. A management system for a computer system including a plurality of resources, the management system comprising:
an interface device coupled to the computer system;
a storage unit that stores management information that is information including information about the plurality of resources; and
a processor coupled to the interface device and the storage unit, wherein
the plurality of resources comprise: a plurality of logical volumes; and a plurality of computer resources including a plurality of kinds of computer resources,
the computer system comprises a server system including two or more computer resources included in the plurality of computer resources,
the processor is configured to
(A) receive designation of an app (application program) usage from a manager,
(B) refer to the management information, and
(C) for a target virtual server that is a virtual server that executes an app of the designated app usage, determine at least one of a specification of resources allocated for exclusive use and a specification of resources allocated for shared use in accordance with an app requirement associated with the designated app usage, and
the specification of resources is at least one of a kind of resources, an app usage associated with resources, and the number of resources.

2. The management system according to claim 1, wherein
the designation in (A) is change designation that is one of designation associated with app requirements after change regarding the designated app usage among a plurality of app usages indicated in template information, which is information including app requirements associated with each app usage and included in the management information, and designation associated with the number of apps after change regarding the designated app usage, and
when resources regarding at least one same kind of resources are insufficient due to the change according to the change designation, the determination in (C) is determination of adding the insufficient resources for the target virtual server.

3. The management system according to claim 2, wherein
the computer system comprises a plurality of subsystems obtained by logical partitioning from the server system to the plurality of logical volumes,
a first subsystem of the plurality of subsystems is a production system that is a subsystem belonging to a production environment,
a second subsystem of the plurality of subsystems is a development system that is a subsystem belonging to a development environment, and
when resources regarding at least one same kind of recourses are insufficient due to the change according to the change designation, the determination in (C) is determination of adding the insufficient resources from the development system regarding the target virtual server in the production system.

4. The management system according to claim 3, wherein
a pool that is a set of one or more logical volumes is allocated to the target virtual server,
a storage area is allocated from the pool allocated to the target virtual server to a virtual volume designated by a write request from the target virtual server in the computer system, and
when the same kind of resources are logical volumes, the determination in (C) is determination of adding the logical volumes of the insufficient capacity from the development system to the pool allocated to the target virtual server.

5. The management system according to claim 1, wherein
the computer system comprises two or more server systems including first and second server systems coupled through a communication network,
the target virtual server is in the first server system, and
the determination in (C) is determination of performing allocation of at least one of allocation for exclusive use and allocation for shared use of the resources in at least one of the two or more server systems regarding the target virtual server.

6. The management system according to claim 5, wherein
each of the first and second server systems comprises one or more logical volumes based on one or more storage devices included in the server system, and
when the logical volumes are insufficient in the first server system regarding the target virtual server, the determination in (C) is
determination of allocating the logical volumes of the second server system regarding the target virtual server and
determination of migrating the target virtual server from the first server system to the second server system.

7. The management system according to claim 1, wherein
the computer system comprises a server system and a storage system,
the server system comprises a plurality of server apparatuses comprising a plurality of server ports,
the storage system comprises: a plurality of storage ports coupled to the plurality of server ports; and the plurality of logical volumes,
the plurality of resources comprise the plurality of server ports and the plurality of storage ports,
a coupling relationship between the server ports and the storage ports is a one-to-one relationship,
an app usage is associated with at least one of the server ports and the storage ports, and
for each of the plurality of virtual servers provided with a plurality of computer resources included in the plurality of server apparatuses, at least one of the server ports and the storage ports allocated for exclusive use or allocated for shared use to the virtual server is a port associated with the same app usage as the app usage of the app executed by the virtual server.

8. The management system according to claim 7, wherein
the designation in (A) is change designation that is one of designation associated with app requirements after change regarding the designated app usage among a plurality of app usages indicated in template information, which is information including app requirements associated with each app usage and included in the management information, and designation associated with the number of apps after change regarding the designated app usage, and
when computer resources regarding at least one same kind of computer resources are insufficient due to the change according to the change designation, the determination in (C) is determination of adding, for the target virtual server, the insufficient computer resources from a target server apparatus that is a server apparatus which executes the target virtual server.

9. The management system according to claim 8, wherein
when the same kind of computer resources are the server ports, the determination in (C) is determination of changing the app usage associated with at least one port of the server ports of the target server apparatus and the storage ports coupled to the server ports to the app usage designated in (A).

10. The management system according to claim 7, wherein
if the computer resources of the target server apparatus become insufficient when the insufficient resources are added for the target virtual server from the target server apparatus, the determination in (C) is
(x1) determination of migrating the virtual server from the target server apparatus to the server apparatus at a migration destination, and
(x2) determination of associating the app usage of the app executed by the virtual server with at least one port of the server ports of the server apparatus at the migration destination and the storage ports coupled to the server ports.

11. The management system according to claim 10, wherein
the computer system comprises a plurality of subsystems obtained by logical partitioning from the server system to the storage system,
a first subsystem of the plurality of subsystems is a production system that is a subsystem belonging to a production environment,
a second subsystem of the plurality of subsystems is a development system that is a subsystem belonging to a development environment,
each of the production system and the development system comprises at least part of the plurality of server apparatuses,
the designation in (A) is designation associated with app requirements after change, and
when computer resources regarding at least one same kind of computer resources are insufficient between the app requirements after change and app requirements before change, and the resources are insufficient even if the insufficient resources are added from the development system to the target virtual server, the determination in (C) is the determination of (x1) and (x2).

12. The management system according to claim 7, wherein
the designation in (A) is designation associated with a set of the app usage and the number of apps, and
the determination in (C) is determination of the specification of resources regarding each of a plurality of target virtual servers that execute a plurality of apps according to the designated app usage and the number of apps.

13. The management system according to claim 12, wherein
in (C), the processor is configured to
(c1) logically partition the storage system and
(c2) determine the specification of resources allocated from the plurality of server apparatuses for each of the plurality of target virtual servers after (c1),
in (c1), the processor is configured to associate, with the storage port, the app usage without insufficiency of resources even if the specification of target computer resources is allocated from the server apparatus including the server port coupled to the storage port among the designated app usages, and
the specification of target resources is a specification of computer resources regarding the server system among the specifications of resources according to the app requirements corresponding to the associated app usage.

14. The management system according to claim 1, wherein
the processor is configured to execute a virtual server initial arrangement process including (A) to (C) and a resource allocation changing process including (A) to (C),
in the virtual server initial arrangement process,
the designation in (A) is designation associated with the set of the app usage and the number of apps, and
the determination in (C) is determination of the specification of resources for each of the plurality of target virtual servers that execute the plurality of apps according to the designated app usage and the number of apps, and
in the resource allocation changing process,
the designation in (A) is change designation that is one of designation associated with the app requirements after change regarding the designated app usage among the plurality of app usages indicated in the template information, which is information including the app requirements associated with each app usage and included in the management information, and designation associated with the number of apps after change regarding the designated app usage, and
the determination in (C) is determination of changing the specification of resources of the target virtual server in accordance with the change designation.

15. A management method of a computer system comprising a plurality of resources, the management method comprising:
receiving designation of an app (application program) usage from a manager;
referring to management information that is information including information about the plurality of resources; and
for a target virtual server that is a virtual server that executes an app of the designated app usage, determining at least one of a specification of resources allocated for exclusive use and a specification of resources allocated for shared use in accordance with app requirements associated with the designated app usage, wherein
the plurality of resources comprise: a plurality of logical volumes; and a plurality of computer resources including a plurality of kinds of computer resources,
the computer system comprises a server system including two or more computer resources included in the plurality of computer resources, and
the specification of resources is at least one of a kind of resources, an app usage associated with resources, and the number of resources.
